(19) United States
(12) Patent Application Publication
(10) Pub. No.: US 2008/0235232 A1
(43) Pub. Date: Sep. 25, 2008

(54) System and/or Method for Sharing and Evaluating Dietary Information

(76) Inventors: Lenny Moses, Victoria (AU); Rodney Moses, Victoria (AU); Eshell Baron, Victoria (AU)

Correspondence Address: HANLEY, FLIGHT & ZIMMERMAN, LLC, 150 S. WACKER DRIVE, SUITE 2100, CHICAGO, IL, 60606, US

(21) Appl. No.: 12/093,429

(22) PCT Filed: Sep. 7, 2007
(86) PCT No.: PCT/AU2007/001327

§ 371 Date: May 12, 2008

(30) Foreign Application Priority Data
Sep. 7, 2006 (AU) 2006904921

(51) Int. Cl. G06F 17/30; G06F 17/00; G06F 7/00

(52) U.S. Cl. 707/9; 707/102; 707/10; 707/E17.005; 707/E17.032; 707/E17.001

(57) ABSTRACT

The present invention provides a system (10) and/or method (100,200,300) for sharing and evaluating dietary information. The system (10) enables the creation of an interactive community of diet, nutrition and/or weight conscious individuals that can interactively exchange opinions, information and results to generate objective and useful information that other members of the community can utilise to help achieve their diet nutrition and/or weight management needs and/or goals. Individuals are able to compare their performance in following a particular diet or program with other individuals who may be following the same diet or program. Individuals may also submit and publish their and opinions as to the suitability of particular foods, food sub groups, recipes and/or ingredients to particular diets and/or programs so that other individuals can assess those opinions to help them make informed decisions to meet their own personal needs and/or goals.

### TECHNICAL FIELD

The present invention relates, generally, to a system and/or method for sharing and evaluating information and relates particularly, though not exclusively, to an interactive system and/or method which enables users to share and evaluate dietary information over a communications network. More particularly, the present invention relates to a system and/or method for providing a virtual or online community that enables users to share and objectively assess and evaluate the applicability of available diet and/or nutrition information to facilitate the making of informed decisions in managing their diet, nutrition and/or weight management needs and/or goals.

It will be convenient to hereinafter describe the invention in relation to a system and/or method for sharing and evaluating dietary information, however it should be appreciated that the present invention is not limited to that use only. The system and/or method of the present invention may also enable users to share and evaluate other forms of information or products without departing from the spirit and scope of the invention as hereinafter described. Suitable forms of other information include, but are not limited to, cosmetic information, exercise or fitness information, and/or wellbeing information.

Similarly, although the present invention is hereinafter described in relation to an interactive system and/or method which is provided to users via the World Wide Web (hereinafter simply referred to as “WWW”), it should be appreciated that the present invention is not limited to that use only.

### BACKGROUND ART

Any discussion of documents, devices, acts or knowledge in this specification is included to explain the context of the invention. It should not be taken as an admission that any of the material forms a part of the prior art base or the common general knowledge in the relevant art in Australia or elsewhere on or before the priority date of the disclosure and claims herein.

In developed countries around the world, there is significant interest in diet, nutrition and weight management for individuals and ultimately the impact it has on people's lives. Entire industries have been developed to assist individuals with their diet, nutrition and/or weight management. There is an enormous volume of information and products available in the market place, most of which is based around a fee for service or product model whereby developers of weight loss programs earn money by making their programs publicly available through sources such as books, videos, meetings and/or packaged foods.

Despite there being a plethora of information, resources and tools available on this topic, a large proportion of the population in these countries is becoming overweight and often obese, heightening the risk of many health related problems developing such as diabetes and heart disease. These undesirable health conditions contribute to reducing the quality of life for people and in some cases shortening their lifespan. A significant proportion of the population is becoming obese and whether the principal cause is the consumption of excess calories, deficiencies in the amount of exercise undertaken or other observable reasons, the increasing trend of weight related health problems is alarming.

One of the key reasons for the disconnect between the tremendous volume of diet, nutrition and/or weight management information and products available, and the surge in the number of overweight people and the associated health problems, is the difficulty for people to cut through the mass of information on the market and find quality objective advice which is capable of implementation for them. What is needed is a way to provide diet and/or nutrition conscious individuals with a structured system which provides them with the ability to share and objectively assess the applicability of available diet and/or nutrition information and/or products to enable them to facilitate the making of informed decisions in managing their diet, nutrition and/or weight management needs and/or goals.

It is believed that the most abundant and highly valuable source of information on diet, nutrition and/or weight management issues is the sum of the views, performances, achievements and recommendations of individuals that make up the broader community. Hence, an interactive system which harnesses the collective contribution and input of members of a virtual community to produce and shape the underlying information and recommendations for the community would be extremely valuable.

It is therefore an object of the present invention to provide a system and/or method for sharing and evaluating dietary information.

### DISCLOSURE OF THE INVENTION

According to one aspect of the present invention there is provided a method for sharing and evaluating information, preferably dietary information, the method including the steps of: providing a central repository for storing and sharing information; providing a plurality of users with controlled access to the central repository and the information stored therein; storing public information in the central repository and making the public information available to all of the plurality of users; receiving personal information from at least one of the plurality of users, storing the personal information in the central repository, and selectively making the personal information available to all of the plurality of users; receiving feedback information from at least one of the plurality of users regarding the public and/or personal information stored in the central repository; manipulating the feedback information, storing the manipulated feedback information in the central repository and making the manipulated feedback information available to all of the plurality of users, wherein the manipulated feedback information enables the plurality of users to evaluate the public and/or personal information stored in the central repository.

Preferably the method for sharing and evaluating information further includes the step of: receiving a profile from each of the plurality of users, storing each of the profiles in the central repository, and selectively making all or part of the profiles available to all of the plurality of users. Preferably each of the profiles includes, but is not limited to, information regarding a user's sex, age, geographic location, height, weight, and/or their threshold or tolerance levels for particular foods and/or ingredients. By making the profile information available, the plurality of users are further able to evaluate the public and/or personal information by considering that information and the manipulated feedback information in association with the profiles of the plurality of users.

In a practical preferred embodiment, the public information includes, but is not limited to, information regarding well known diet and/or weight loss programs, and the personal information includes, but is not limited to, information regarding personal diet and/or weight loss programs captured from at least one of the plurality of users. In this practical preferred embodiment, the public and/or personal diet and/or program information is made available to the plurality of users for the purpose of enabling those users to selectively follow same. In this embodiment, it is preferred that the feedback information received, preferably on an on-going basis, from the at least one of the plurality of users includes performance data for that user which represents their performance, for example their weight loss, achieved whilst following a particular public and/or personal diet and/or weight loss program stored on the central repository.

Preferably the step of receiving personal information, i.e. the personal diet and/or program information, from at least one of the plurality of users, storing the personal information in the central repository, and selectively making the personal information available to all of the plurality of users, includes the steps of: prompting the user to enter a general description of their personal diet and/or program; prompting the user to enter key features and a description of the purpose of their diet and/or program; prompting the user to enter any essential tips associated with their diet and/or program; prompting the user to enter any key nutritional requirements associated with their diet and/or program; prompting the user to enter any food group constraints associated with their diet and/or program; capturing any of the above information entered by the user, and storing the captured information in the central repository; and, prompting the user for permission to make the stored information available to all of the plurality of users, and if the user provides permission, making the personal information available to all of the plurality of users having access to the central repository.

Preferably the steps of: receiving feedback information, i.e. the performance data, from at least one of the users regarding the public and/or personal information, i.e. the diet and/or program information, stored in the central repository; and, manipulating the feedback information, storing the manipulated feedback information in the central repository and making the manipulated feedback information available to all of the plurality of users; include the steps of: prompting the user to enter their performance data for the particular diet and/or program being followed; prompting the user to enter the date and time of entering their performance data, or automatically recording the date and time after the performance data is entered; prompting the user to enter where they are at relative to the stage and/or phase of the diet and/or program since their last performance data was entered; capturing any of the above feedback information entered by the user, and storing the captured feedback information in the central repository; determining the rate of change of metrics of that user compared to the last time their performance data was entered; manipulating the stored feedback information into a plurality of different configurations for evaluation purposes utilising, for example, the rate of change of metrics previously determined; and, making the manipulated feedback information available to all of the plurality of users so that they can evaluate the public and/or personal information stored in the central repository.

Preferably the public information stored in the central repository further includes information about specific foods, recipes and/or individual ingredients, more particularly their nutritional compositions including, but not limited to, their fat content, carbohydrate levels, and/or protein ratings. It is further preferred that this food, recipe and/or ingredient information is stored in food sub-categories or groups within the central repository, with each food group being, for example, based on a threshold or tolerance level for a particular diet or category of individual.

Preferably the personal information received from the at least one of the plurality of users, stored in the central repository, and selectively made available to all of the plurality of users, further includes personal recipe information which other users can utilise to assist them to achieve their diet and/or weight loss goals.

In a practical preferred embodiment, wherein the public information includes food, recipe and/or ingredient information, and the personal information includes personal recipe information, the step of receiving personal information from at least one of the plurality of users, storing the personal information in the central repository, and selectively making the personal information available to all of the plurality of users, further includes the steps of: (i) prompting the user to enter general information about their recipe; (ii) prompting the user to enter the preparation and/or cooking instructions required to prepare their recipe; (iii) prompting the user to enter a brief description of an ingredient of their recipe; (iv) searching the public information stored on the central repository to locate an ingredient that matches the brief description, and when a matching ingredient is found, prompting the user to enter the quantity and/or units of that located ingredient required for their recipe; (v) repeating steps (iii) and (iv) until all ingredients of the recipe have been located and their specific quantities and/or units entered; and (vi) capturing the above recipe information entered by the user, and storing the captured information in the central repository; and, (vii) prompting the user for permission to make the stored recipe information available to all of the plurality of users, and if the user provides permission, making the personal recipe information available to all of the plurality of users having access to the central repository.

In this practical preferred embodiment, the method for sharing and evaluating information utilises the public food, recipe and/or ingredient information stored on the central repository as a look-up table during the capture, storage and subsequent (selective) publication of a users personal recipe. In this way, information regarding the nutritional compositions of the specific ingredients forming part of the captured recipe are known and same can be shared with the plurality of users for the purposes of evaluation of that recipe, and hence, the plurality of users can determine the suitability of that recipe for their own individual needs and/or requirements. Further, since the nutritional thresholds or preferences for a particular (public or personal) diet and/or program are also stored on the central repository, the method for sharing and evaluating dietary information preferably also includes the steps of: determining whether a personal recipe, and/or a particular ingredient of that recipe, stored on the central repository is suitable for a particular diet and/or program (public or personal), and, alerting users as to the suitability of that personal recipe, and/or the particular ingredient(s), to the particular diets and/or programs stored on the central repository.

In a further practical preferred embodiment, wherein the public information includes food, recipe and/or ingredient information, and the personal information includes personal recipe information, it is preferred that the feedback information received from the at least one of the plurality of users further includes personal assessment data as to whether a particular food, food sub group, recipe and/or ingredient (public or personal) stored on the central repository is suitable for a particular diet and/or program (public or personal) that is also stored on the central repository. In this practical preferred embodiment, the step of receiving feedback information, further includes the steps of: prompting the user to enter feedback information (assessment data) regarding their opinion as to the suitability of a particular food, food sub group, recipe and/or ingredient to a particular diet and/or program (public or personal) stored on the central repository; capturing the feedback information entered by the user, and storing the captured feedback information in the central repository; manipulating the stored feedback information for evaluation purposes; and, making the manipulated feedback information available to all of the plurality of users so that they can evaluate the suitability of the public and/or personal information (i.e. food, food sub group, recipe and/or ingredient information) stored in the central repository. In this way, users can also evaluate the opinions of other users regarding the suitability of particular foods, food sub groups, recipes and/or ingredients to particular diets and/or programs (public or personal) stored on the central repository in order to determine the suitability of those foods or recipes for their own individual needs and/or requirements.

In a practical preferred embodiment the central repository is at least one computing device which preferably includes at least one processor which is operable to execute software that maintains and controls access to the information for the plurality of users. Preferably the information is stored on at least one memory unit associated with the at least one computing device.

In a further practical preferred embodiment the at least one computing device is a web-server accessible to the plurality of users via a communications network, preferably the Internet, wherein each of the plurality of users can access the web-server via at least one user operable terminal which may be permanently, or selectively, connected to the communications network. Preferably the at least one user operable terminal is selected from the group consisting of: a PDA; a mobile or cellular telephone; a personal, tablet or notebook computer; or any other suitable communications device. It is preferred that the method for sharing and evaluating information provides an online or virtual community which is accessible to users in real time, i.e. “live”.

According to a further aspect of the present invention there is provided a computer-implemented method for sharing and evaluating information, preferably dietary information, wherein at least a portion of the information is manipulated for the purpose of evaluation of that information, and wherein the manipulation of the information is performed within memory of a computing device, the method including the steps of: providing a central repository on the computing device for storing and sharing information; providing a plurality of users with controlled access to the computing device, the central repository and the information stored therein; storing public information in the central repository and making the public information available to all of the plurality of users; receiving personal information from at least one of the plurality of users, storing the personal information in the central repository, and selectively making the personal information available to all of the plurality of users; acquiring in the memory of the computing device feedback information from at least one of the plurality of users regarding the public and/or personal information stored in the central repository; manipulating the feedback information within the memory of the computing device, storing the manipulated feedback information in the central repository and making the manipulated feedback information available to all of the plurality of users, wherein the manipulated feedback information enables the plurality of users to evaluate the public and/or personal information stored in the central repository.

According to yet a further aspect of the present invention there is provided a machine readable medium storing a set of instructions that, when executed by a machine, cause the machine to execute a method for sharing and evaluating information, preferably dietary information, the method including the steps of: providing a central repository for storing and sharing information; providing a plurality of users with controlled access to the central repository and the information stored therein; storing public information in the central repository and making the public information available to all of the plurality of users; receiving personal information from at least one of the plurality of users, storing the personal information in the central repository, and selectively making the personal information available to all of the plurality of users; receiving feedback information from at least one of the plurality of users regarding the public and/or personal information stored in the central repository; manipulating the feedback information, storing the manipulated feedback information in the central repository and making the manipulated feedback information available to all of the plurality of users, wherein the manipulated feedback information enables the plurality of users to evaluate the public and/or personal information stored in the central repository.

According to yet a further aspect of the present invention there is provided a computer program including computer program code adapted to perform some or all of the steps of the method as described with reference to any one of the preceding paragraphs, when the computer program is run on a computer.

According to yet a further aspect of the present invention there is provided a computer program according to the preceding paragraph embodied on a computer readable medium.

According to yet a further aspect of the present invention there is provided a system for sharing and evaluating information, preferably dietary information, the system including: at least one processor operable to execute software that maintains and controls access to the information for a plurality of users; at least one memory unit operable to store the information, the information including system installed information that is made available to all of the plurality of users, personal information that is received from at least one of the plurality of users and is subsequently selectively made available to all of the plurality of users, and feedback information that is received from at least one of the plurality of users; at least one input/output device operable to provide an interface for the plurality of users to operate the software in order to share the personal information, access the system installed information, and to provide the feedback information regarding the system installed and/or personal information stored on the at least one memory unit, wherein the feedback information received by the system is manipulated by the software for the purposes of displaying that information to all of the plurality of users for the purpose of evaluation; and, at least one display device operable to present the information to the plurality of users.

In a practical preferred embodiment, the system installed information includes, but is not limited to, information regarding well known diet and/or weight loss programs, and the personal information includes, but is not limited to, information regarding personal diet and/or weight loss programs captured from at least one of the plurality of users. In this practical preferred embodiment, the system installed and/or personal diet and/or program information is made available to the plurality of users for the purpose of enabling those users to selectively follow same. In this embodiment, it is preferred that the feedback information received, preferably on an on-going basis, from the at least one of the plurality of users is performance data for that user which represents their performance, for example their weight loss, achieved whilst following that diet and/or weight loss program.

Preferably the personal information, i.e. the personal diet and/or program information, is received from at least one of the plurality of users, by utilising a software module of the system which when executed by the at least one processor: prompts the user to enter a general description of their personal diet and/or program; prompts the user to enter key features and a description of the purpose of their diet and/or program; prompts the user to enter any essential tips associated with their diet and/or program; prompts the user to enter any key nutritional requirements associated with their diet and/or program; prompts the user to enter any food group constraints associated with their diet and/or program; captures any of the above information entered by the user, and stores the captured information in the at least one memory unit; and, prompts the user for permission to make the stored information available to all of the plurality of users, and if the user provides permission, makes the personal information available to all of the plurality of users having access to the system.

Preferably the feedback information, i.e. the performance data of at least one of the users, is received from at least one of the plurality of users, and subsequently manipulated utilising a software module of the system which when executed by the at least one processor: prompts the user to enter their performance for the particular diet and/or program being followed; prompts the user to enter the date and time of entering their performance data, or automatically records the date and time after the performance data is entered; prompts the user to enter where they are at relative to the stage and/or phase of the diet and/or program since their last performance data was entered; captures any of the above feedback information entered by the user, and stores the captured feedback information in the at least one memory unit; determines the rate of change of metrics of that user compared to the last time their performance data was entered; manipulates the stored feedback information into a plurality of different configurations for evaluation purposes utilising, for example, the rate of change of metrics previously determined; and, makes the manipulated feedback information available to all of the plurality of users so that they can evaluate the public and/or personal information stored in the at least one memory unit.

Preferably the system installed information stored in the at least one memory unit further includes information about specific foods, recipes and/or ingredients, more particularly their nutritional compositions including, but not limited to, their fat content, carbohydrate levels, and/or protein ratings. It is further preferred that this food, recipe and/or ingredient information is stored in food sub-categories or groups within the at least one memory unit, with each food group being, for example, based on a threshold or tolerance level for a particular diet or category of individual.

Preferably the personal information received from the at least one of the plurality of users, stored in the at least one memory unit, and selectively made available to all of the plurality of users, further includes personal recipe information which other users can utilise to assist them to achieve their diet and/or weight loss goals.

In a practical preferred embodiment, wherein the system installed information includes food, recipe and/or ingredient information, and the personal information includes recipe information, the system also includes a software module, which when executed by the at least one processor, (i) prompts the user to enter general information about their recipe; (ii) prompts the user to enter the preparation and/or cooking instructions required to prepare their recipe; (iii) prompts the user to enter a brief description of an ingredient of their recipe; (iv) searches the system installed information stored on the at least one memory unit to locate an ingredient that matches the brief description, and when a matching ingredient is found, prompts the user to enter the quantity and/or units of that located ingredient required for their recipe; (v) repeats steps (iii) and (iv) until all ingredients of the recipe have been located and their specific quantities and/or units entered; and (vi) captures the above recipe information entered by the user, and stores the captured information in the at least one memory unit; and, (vii) prompts the user for permission to make the stored recipe information available to all of the plurality of users, and if the user provides permission, makes the personal recipe information available to all of the plurality of users having access to the system.

In a further practical preferred embodiment, wherein the system installed information includes food, recipe and/or ingredient information, and the personal information includes personal recipe information, it is preferred that the feedback information received from the at least one of the plurality of users further includes personal assessment data as to whether a particular food, food sub group, recipe and/or ingredient (system installed or personal) stored in the at least one memory unit is suitable for a particular diet and/or program (system installed or personal) that is also stored in the at least one memory unit.

In a practical preferred embodiment the system includes at least one computing device having the at least one processor and the at least one memory unit associated therewith. Preferably the at least one computing device is connected to a communications network. It is also preferred that the at least one computing device is a web-server accessible to the plurality of users via the communications network, preferably the Internet. In this practical preferred embodiment the at least one input/output device and the at least one display device are associated with at least one user operable terminal, wherein each of the plurality of users can access the web-server via at least one user operable terminal which may be permanently, or selectively, connected to the communications network. Preferably the at least one user operable terminal is selected from the group consisting of: a PDA; a mobile or cellular telephone; a personal, tablet or notebook computer; or any other suitable communications device. It is preferred that the method for sharing and evaluating information provides an online or virtual community which is accessible to users in real time, i.e. “live”.

According to yet a further aspect of the present invention there is provided a system for sharing and evaluating dietary information, the system being operable over a communications network, preferably the Internet, the system including: at least one central computer server connected to the communications network, the at least one central computer server, preferably a web-server, acting as a central repository for storing and sharing the dietary information; and, at least one user operable terminal which can be selectively connected to the communications network for inputting, storing, viewing and retrieving the dietary information from the at least one central computer server, wherein the dietary information stored on the at least one central computer server includes feedback information received from a user of at least one user operable terminal, the feedback information being manipulated and subsequently made available to all users of the at least one user operable terminal for the purposes of evaluation of other dietary information stored on the at least one central computer server.

### ADVANTAGES OF THE INVENTION

Accordingly, the present invention provides a system, method and/or computer program for sharing and evaluating information, preferably dietary information, and preferably via a communications network, such as, for example, the WWW.

In its preferred form, the present invention provides a software and/or hardware system which is operable to enable individuals to make informed decisions in relation to diet, nutrition and/or weight management. The system, which is preferably provided by an interactive software provider, provides an interactive software environment that is preferably delivered via a communications network, such as, for example, the WWW or the Internet, and/or any other suitable network. The system of the present invention preferably enables the creation of a virtual community of diet, nutrition and/or weight conscious individuals that can interactively exchange opinions, information and results to generate objective and useful information that other members of the community can utilise to help achieve their diet, nutrition and/or weight management goals.

According to an important aspect of the present invention individuals are able to compare their performance in following a particular diet or program with other individuals who may be following the same diet or program, based on a set of criteria such as, for example, age, sex, and/or geographic location. The system may enable individuals to submit and nominate food ingredients, recipes, and/or suggestions, and may also enable them to provide feedback (i.e. assessment data) regarding same, so that other individuals who are recorded as following a particular diet or program, can view the shared information to assess the suitability of the food ingredient, recipe and/or suggestion for their own personal needs.

In a preferred form, the system of the present invention may store, classify and make available to users well known and/or popular weight loss programs and/or diets to facilitate comparison between the programs and/or diets and provide a means for individuals to assess the suitability of the programs and/or diets for their individual needs. Using a structured framework, individuals may also create their own personal diet which can be shared and followed by other members of the virtual community.

The system enables the aggregation of performance and/or assessment data inputted by users for particular diets and/or programs and dissemination of the resulting information in a multitude of different configurations such as, for example, weight loss achieved on a particular diet and/or program for certain individuals according to a particular profile such as age or sex, over a specified period of time. The system preferably also enables users to determine whether performance and/or assessment data provided by other users should be considered relevant when assessing a specific diet and/or program. One example of such a circumstance when a user may not wish to include performance data provided by another user or users, is when that or those users have not fully committed to, or strictly followed, the specific diet and/or program concerned.

Hence, the system and/or method of the present invention provides users with a means of sharing information whilst also enabling users to evaluate information provided by the system and/or other users to assess the suitability of a particular diet and/or program for their individual needs.

In accordance with a further aspect the system of the present invention incorporates a structured recipe builder which allows individuals to access a food nutritional database in selecting ingredients for a recipe. Using assigned criteria for key nutritional elements for distinct food categories, the system may also establish a framework to assess and inform individuals as to the suitability to the individual of both the separate ingredients and recipes as a whole, based on dietary preferences for the key nutritional elements that have been submitted by the individual. In a further aspect, the system may also enable individuals to submit and publish their own opinions as to the suitability of particular foods, food sub groups, recipes and/or ingredients to particular diets and/or programs so that other individuals can assess those opinions to help them make informed decisions to meet their own personal needs and/or goals.

The present invention therefore provides diet and/or nutrition conscious individuals with a system which provides them with the ability to share and objectively assess the applicability of available diet and/or nutrition information and/or products to facilitate the making of informed decisions in managing their diet, nutrition and/or weight management needs and/or goals.

### BRIEF DESCRIPTION OF THE DRAWINGS

In order that the invention may be more clearly understood and put into practical effect there shall now be described in detail preferred constructions of a system and/or method for sharing and evaluating dietary information in accordance with the invention. The ensuing description is given by way of non-limitative example only and is with reference to the accompanying drawings, wherein:

FIG. 1 is a block diagram of a system for sharing and evaluating dietary information, made in accordance with a preferred embodiment of the present invention;

FIG. 2 is a flow diagram illustrating one embodiment of a method for capturing and selectively publishing dietary information, which is suitable for use with the system for sharing and evaluating dietary information of FIG. 1;

FIGS. 3, 3a & 3b are exemplary graphical user interfaces (e.g. web pages) illustrating various areas of the system for sharing and evaluating dietary information of FIG. 1, whereby users can input dietary information;

FIG. 4 is a flow diagram illustrating one embodiment of a method for capturing and aggregating user performance data, which is suitable for use with the system for sharing and evaluating dietary information of FIG. 1;

FIG. 5 is an exemplary graphical user interface illustrating one of many possible areas of the system for sharing and evaluating dietary information of FIG. 1, whereby users can input ingredient and recipe information;

FIG. 6 is a flow diagram illustrating one embodiment of a method for capturing recipe information, which is suitable for use with the system for sharing and evaluating dietary information of FIG. 1;

FIG. 7 is an exemplary graphical user interface illustrating an example of the use of the system for sharing and evaluating dietary information of FIG. 1, wherein it is shown that a user is able to see the performance data of another user, and a group of users, respectively, after those users have entered their performance data for a particular diet and/or program utilising, for example, the method for capturing and aggregating user performance data of FIG. 4;

FIGS. 8a to 8c are exemplary graphical user interfaces illustrating examples of the use of the system for sharing and evaluating dietary information of FIG. 1, wherein it is shown that a first user can publish their own personal diet and/or program utilising, for example, the method for capturing and selectively publishing dietary information of FIG. 2, and a second user can follow that published personal diet, whilst a third user can view the performance data of both the first and second users whom are following that published personal diet after those users have entered their performance data for that published personal diet utilising, for example, the method for capturing and aggregating user performance data of FIG. 4;

FIGS. 9a & 9b are exemplary graphical user interfaces illustrating an example of the use of the system for sharing and evaluating dietary information of FIG. 1, wherein it is shown that if a personal diet published utilising, for example, the method for capturing and selectively publishing dietary information of FIG. 2, has a particular nutritional composition preference or threshold, the system will analyse the ingredients of a selected recipe, which may have been captured and published utilising the method for capturing recipe information of FIG. 6, to determine the suitability of the ingredients of that recipe based on those particular nutritional composition preferences or thresholds; and

FIGS. 10a & 10b are exemplary graphical user interfaces illustrating an example of the use of the system for sharing and evaluating dietary information of FIG. 1, wherein it is shown that a first user can provide feedback as to whether a particular food sub group is appropriate for a particular published diet and/or program, and a second user can then review the first users feedback to assist them in making informed decisions as to the suitability thereof for their own personal needs and/or requirements.

### MODES FOR CARRYING OUT THE INVENTION

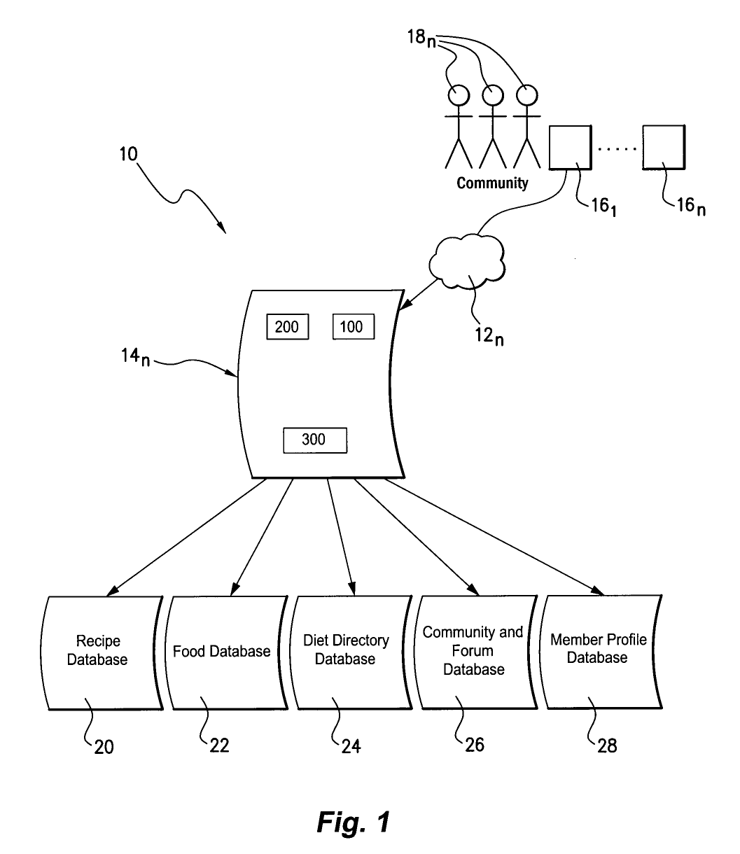

In FIG. 1 there is shown a system 10 for sharing and evaluating information, for example, dietary information as shown. System 10 is suitable for use over a communications network 12ₙ. It should be understood however, that system 10 of the present invention is not limited to that use only.

System 10 includes at least one computer server 14ₙ which hosts and/or maintains a plurality of applications, databases and/or tools that together, provide a means of sharing and evaluating dietary information.

Computer server 14ₙ is designed to receive/transmit data from/to at least one input terminal 16ₙ. The term “Input terminal 16ₙ” refers to any suitable type of computing device capable of transmitting/receiving and displaying data as described herein, including, but not limited to, a Personal Digital Assistant (PDA) as for example a Palm Pilot®, a Wireless Application Protocol (WAP) capable communications device, as for example, a mobile or cellular phone, and/or any other suitable computing device, as for example a personal/desktop, or notebook computer.

Computer server 14ₙ is configured to communicate with input terminals 16ₙ via any suitable communications connection or network 12ₙ (hereinafter referred to simply as a “network(s) 12ₙ”). Each input terminal 16ₙ may communicate with computer server 14ₙ via the same or a different network 12ₙ. Suitable networks 12ₙ include, but are not limited to: a Local Area Network (LAN); a Personal Area Network (PAN), as for example an Intranet; a Wide Area Network (WAN), as for example the Internet or WWW; a Wireless Application Protocol (WAP) network; a Bluetooth network; and/or any suitable WiFi network (wireless network). Computer server 14ₙ may include various types of hardware and/or software necessary for communicating with input terminals 16ₙ and/or additional computers/hardware (not shown) as for example routers, switches and/or access points, each of which would be deemed appropriate by persons skilled in the relevant art.

Input terminals 16ₙ are each configured to be operated by at least one user 18ₙ of system 10. The term “user 18ₙ” refers to any person in possession of, or stationed at, at least one input terminal 16ₙ whom is able to operate input terminal 16ₙ and transmit and/or receive data, as for example, a diet and/or nutrition conscious individual, a diet, nutrition and/or medical professional, such as, for example, a dietician, a nutritionist, or a doctor, and/or a product manufacturer, supplier or reseller. Input terminals 16ₙ may include various types of software and/or hardware required for capturing and/or displaying data including, but not limited to: web browser and/or other graphical user interface application(s) (hereinafter referred to simply as “GUI application(s)”); word processing application(s); monitor(s), GUI pointing devices and/or any other suitable data acquisition or display device(s). Similarly, input terminals 16ₙ may also include various types of software and/or hardware suitable for transmitting/receiving data to/from computer server 14ₙ via network(s) 12ₙ.

Although the use of system 10 is specifically described with reference to users 18ₙ utilising input terminals 16ₙ to connect to, and interact with, computer server 14ₙ, via network 12ₙ, it should be appreciated that system 10 of the present invention is not limited to that use only. In an alternative embodiment (not shown) users 18ₙ may simply interact directly with computer server 14ₙ which may be their own personal computing device or a public computing device, as for example an Internet kiosk, library or Internet Café computing device(s). In this alternative embodiment, system 10 could be provided entirely by a single computing server 14ₙ as a software and/or hardware application(s) and as such input terminals 16ₙ and network 12ₙ would not be essential to the operation of system 10. The present invention is therefore not limited to the specific arrangement shown in the drawings.

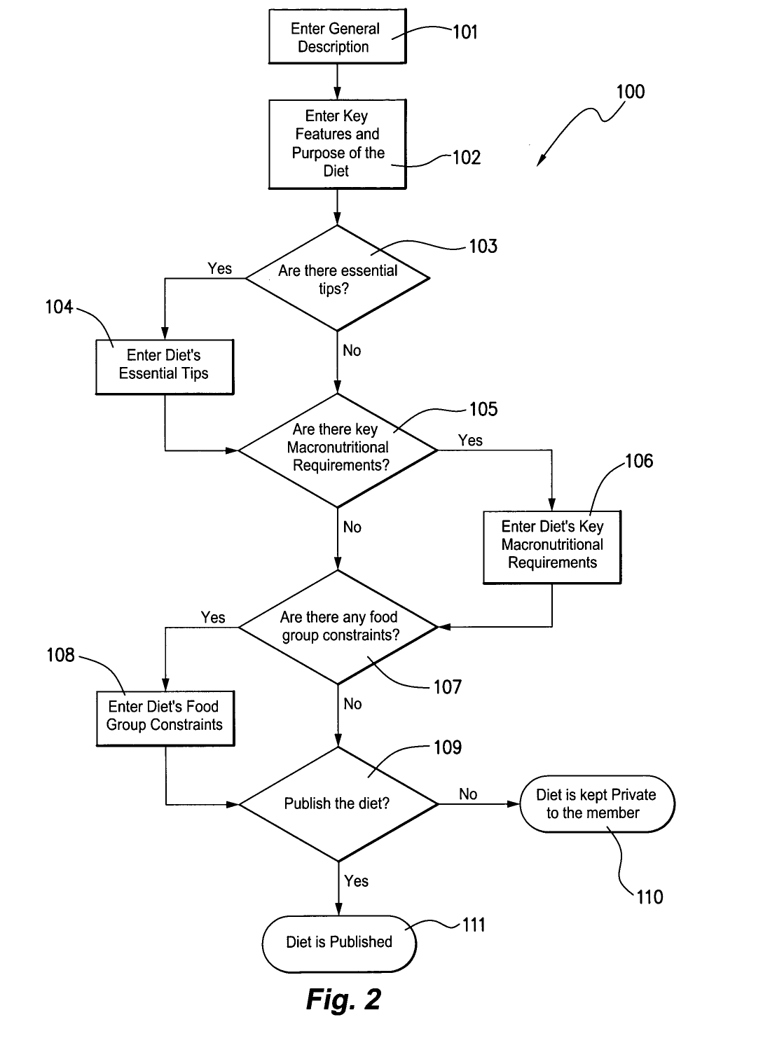

As is shown in FIG. 1, and explained in more detail with reference to FIG. 2 to 10b, it is preferred that computer server 14ₙ is at least one web-server, or is connected via network(s) 12ₙ to at least one additional computer server 14ₙ (not shown) acting as a web-server, such that system 10 is an online service accessible to users 18ₙ in possession of, or stationed at, input terminals 16ₙ connected to the Internet (network(s) 12ₙ). It is especially preferred that computer server 14ₙ, of system 10, provides an online or virtual interactive environment, wherein users 18ₙ stationed at input terminals 16ₙ constitute the individual members of a diet and/or nutrition conscious “community” (see FIG. 1).

System 10 may be offered to users 18ₙ for free, or may be offered to users 18ₙ on an “on demand” Application Service Provider (hereinafter simply referred to as “ASP”) basis, with use thereof being charged accordingly. ASP usage may only apply to a select group of users 18ₙ, such as, for example, professional and/or supplier users 18ₙ, who may wish to make their products and/or services available via system 10 with a view of making a profit for the supply and/or sale thereof.

It is preferred that computer server 14ₙ utilises security to validate access from input terminals 16ₙ. It is also preferred that computer server 14ₙ performs validation functions to ensure the integrity of data transmitted between computer server 14ₙ and input terminals 16ₙ. A person skilled in the relevant art will appreciate such technologies and the many options available to achieve a desired level of security and/or data validation, and as such a detailed discussion of same will not be provided. Accordingly, the present invention should be construed as including within its scope any suitable security and/or data validation technologies as would be deemed appropriate by a person skilled in the relevant art.

Communication and/or data transfer (or data capture) between input terminals 16ₙ and computer server 14ₙ, via network(s) 12ₙ, may be achieved utilising any suitable communication and/or data transfer protocol, such as, for example, File Transfer Protocol (hereinafter simply referred to as “FTP”), Hypertext Transfer Protocol (hereinafter simply referred to as “HTTP”), Electronic Mail (hereinafter simply referred to as “e-mail”), Transfer Control Protocol/Internet Protocol (hereinafter simply referred to as “TCP/IP”), Short Message Service (hereinafter simply referred to as “SMS”), Multimedia Message Service (hereinafter simply referred to as “MMS”), any suitable Internet based message service, any combination of the preceding protocols and/or technologies, and/or any other suitable protocol or communication technology that allows delivery of data and/or communication between input terminals 16ₙ and computer server 14ₙ.

Access to computer server 14ₙ, and the transfer of data between input terminals 16ₙ and computer server 14ₙ, may be intermittently provided (for example, upon request), but is preferably provided “live”, i.e. in real-time.

Computer server 14ₙ, of system 10, provides (see particularly FIGS. 1, 2, 4 & 6) a plurality of applications, databases and/or tools (such as software and/or hardware modules or processes) that enable multiple aspects of system 10 to be provided over network 12ₙ. These applications, databases and/or tools include, but are not limited to: a recipe database 20; a food and/or ingredient database 22 (hereinafter simply referred to as “food database 22”); a diet information database 24 (hereinafter simply referred to as “diet database 24”); a community and/or forum database 26 (hereinafter simply referred to as “community database 26”); a member profile database 28 (hereinafter simply referred to as “member database 28”); a module or application for capturing and selectively publishing dietary information 100 (hereinafter simply referred to as “diet capture module 100”); a module or application for the capture, aggregation and dissemination of user 18ₙ outcome and/or performance data 200 (hereinafter simply referred to as “performance data module 200”); and, a module or application for capturing and publishing ingredient and/or recipe information 300 (hereinafter simply referred to as “recipe capture module 300”).

Databases 20,22,24,26,28 are preferably managed by a Database Management System(s) (hereinafter simply referred to as “DBMS(s)”) installed on computer server 14ₙ that enables data to be stored, modified, searched and/or extracted from respective databases 20,22,24,26,28. DBMS(s) (not shown) work with modules 100,200,300 of system 10 to enable the storage, searching and/or extraction of system and/or user 18ₙ input data. DBMS(s) enable information and/or data stored in databases 20,22,24,26,28 to be accessed and shared by users 18ₙ of system 10. A detailed description of each of databases/modules 20,22,24,26,28,100,200,300 of system 10 will now be provided.

### Recipe Database:

Recipe database 20 stores recipe information which is shared with users 18ₙ of system 10. Recipe database 20 preferably stores recipe information input by users 18ₙ of system 10, but may also store pre-installed or pre-inputted recipe information provided by the administrators or owners of system 10. Recipe database 20 also stores data captured by recipe capture module 300.

### Food Database:

Food database 22 stores food and/or ingredient information which is shared with users 18ₙ of system 10. Food database 22 stores information about specific food and/or ingredients and more particularly their nutritional compositions, such as, for example, their fat content, carbohydrate level, and/or protein rating. Food database 22 is used by recipe capture module 300 to assist with the capture and storage of recipe information in recipe database 20.

It is preferred that food and/or ingredients are stored in sub-categories or groups (each food group being, for example, based on a threshold or tolerance level for a particular diet or category of individual) within food database 22 such that system 10 can determine the suitability and/or appropriateness of individual food items and/or entire recipes for a users 18ₙ particular diet and/or program based on the users 18ₙ preferences stored in member database 28.

### Diet Database:

Diet database 24 stores diet information which is shared with users 18ₙ of system 10. Diet database 24 contains (system installed) information relating to well known or popular weight loss programs and/or diets. Diet database 24 also stores personal (user 18ₙ input) diet and/or program information captured by diet capture module 100. A user's 18ₙ personal diet information may be selectively shared with other users 18ₙ of system 10. Users 18ₙ can choose whether they wish to publish their personal diet and/or program information when entering their information using diet capture module 100.

Information contained in diet database 24 is suitably classified to facilitate comparison between the stored programs and/or diets and to provide a means for users 18ₙ to assess the suitability (i.e. evaluate) of particular programs and/or diets for their own specific requirements.

Users 18ₙ can choose to evaluate and/or follow well known (i.e. system installed) or other users 18ₙ personal diet and/or programs.

### Community Database:

Community database 26 stores community and/or forum information which is shared with users 18ₙ of system 10.

### Member Database:

Member database 28 stores personal and public information of users 18ₙ of system 10. During the sign-up process, or when updating their profile information, users 18ₙ can select whether particular aspects of their profile are to be shared with other users 18ₙ of system 10. Member database 28 contains a plurality of user 18ₙ preferences, including, but not limited to, threshold or tolerance levels for particular foods and/or ingredients, age, sex, geographic location, height and/or weight.

User 18ₙ preferences stored in member database 28 are preferably used by system 10 to display dietary and/or nutritional information tailored to the specific needs and/or goals of that user 18ₙ.

### Diet Capture Module:

Diet capture module 100 is a structured application that steps users 18ₙ through a process whereby users 18ₙ can define and selectively publish their personal diet(s) and/or program(s) information. The dietary information of a user 18, captured by module 100 is stored in diet database 24 and is shared with other users 18ₙ if that user 18ₙ selects to allow publication of same.

A flow diagram illustrating a preferred diet capture module (or method) 100 is shown in FIG. 2. The module 100 of FIG. 2 is suitable for use with system 10 of FIG. 1. It should be understood that the embodiment provided in FIG. 2 only illustrates one way in which dietary information can be captured and selectively published in accordance with system 10. Many other methods may be utilised to achieve the same or similar result and as such the present invention is not limited to the specific example provided.

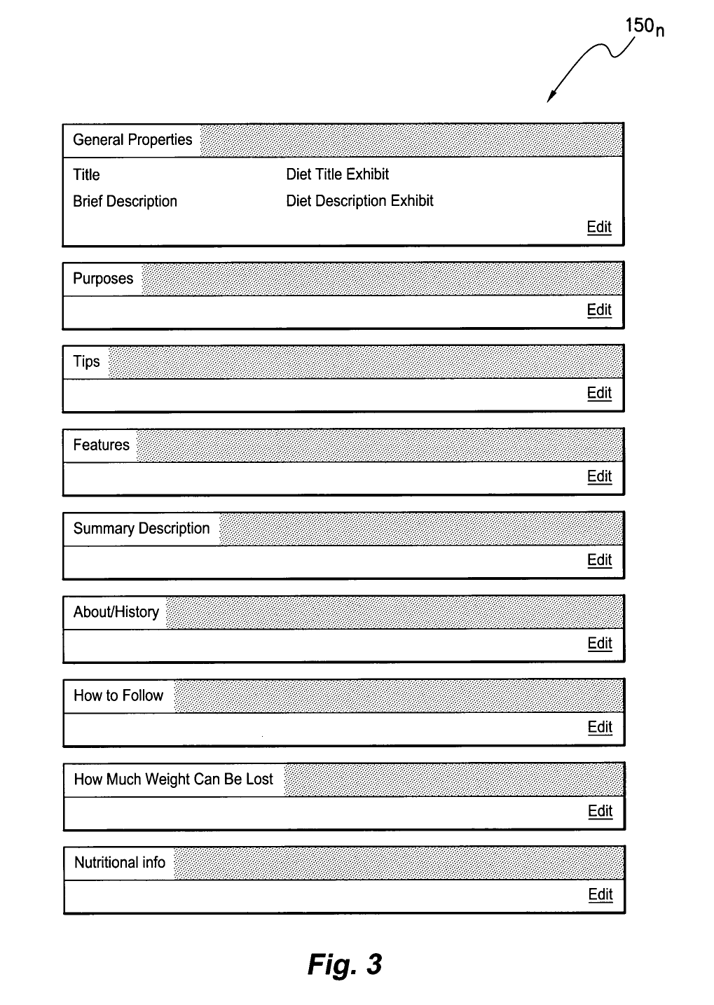

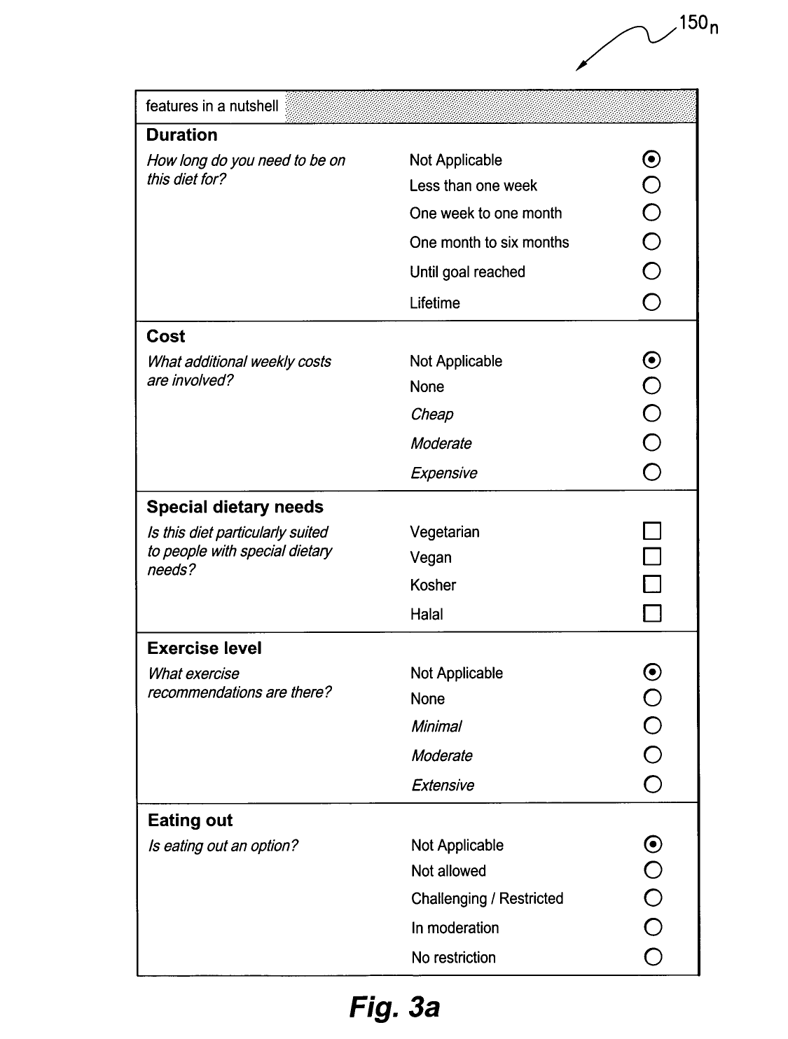

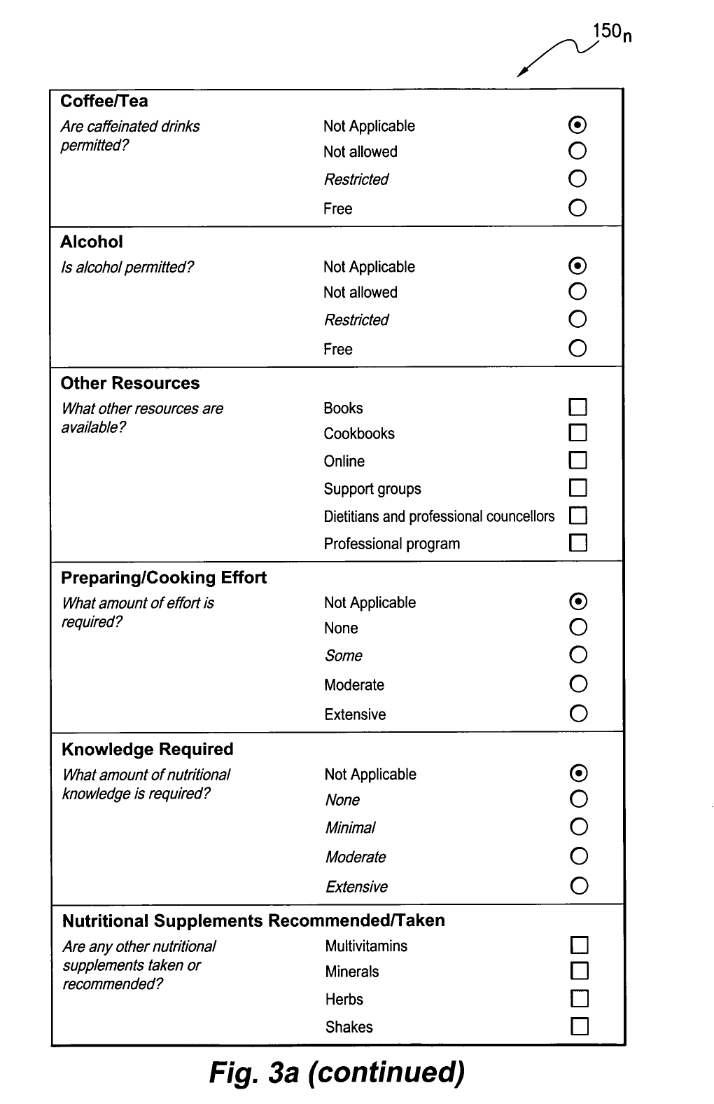

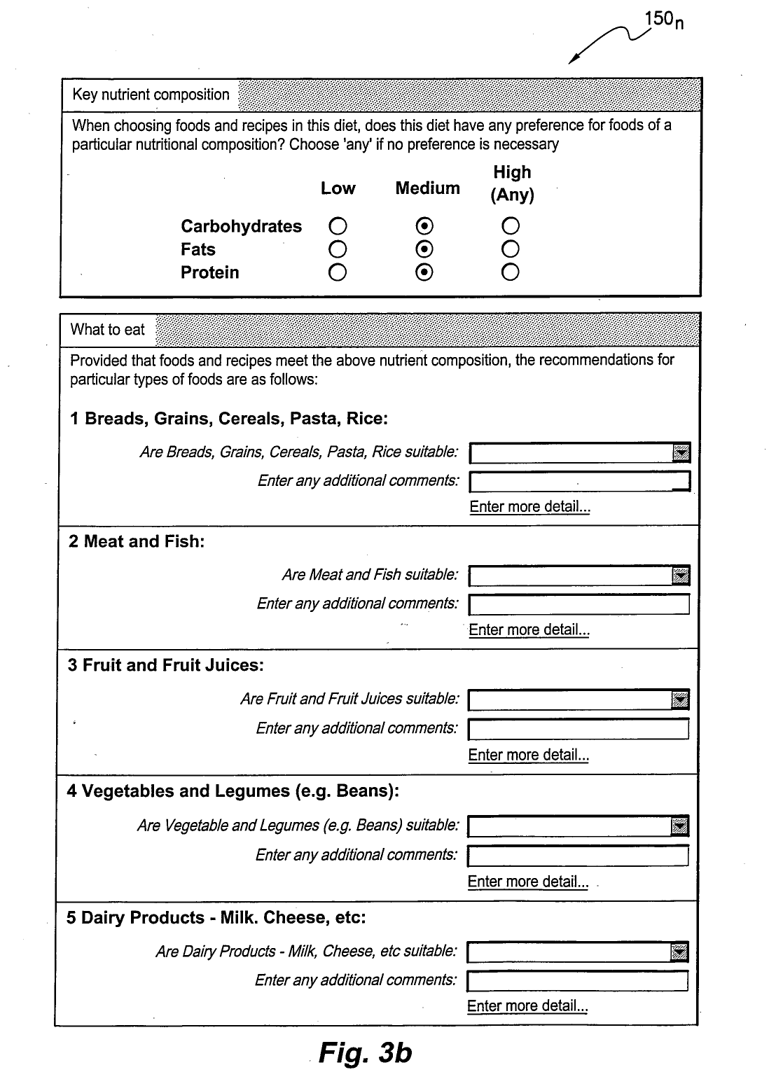

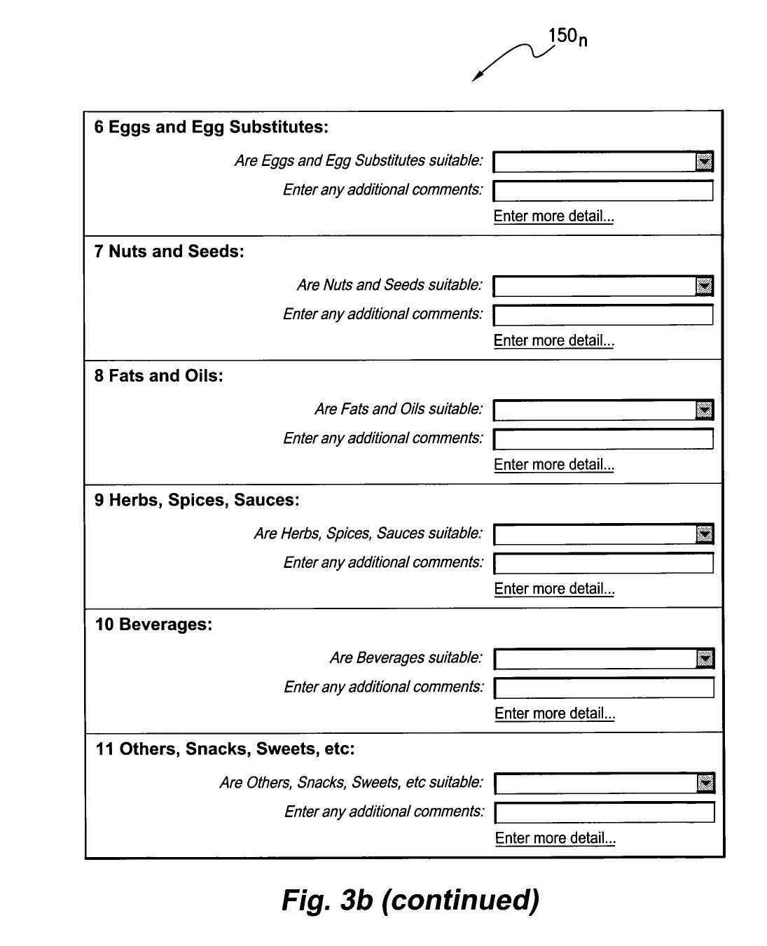

Diet capture module 100 of FIG. 2 will be described in conjunction with FIGS. 3 to 3b, each of which illustrate exemplary GUI's 150ₙ for capturing and selectively sharing dietary information in accordance with diet capture module 100 of FIG. 2. In FIGS. 3 to 3b, within GUI's 150ₙ are shown various web-pages hosted by computer server 14ₙ (web-server) of system 10. It should be appreciated that any suitable GUI(s) 150ₙ can be used depending on the application of system 10, and the way in which computer server 14ₙ is accessible (via network(s) 12ₙ) to users 18ₙ stationed at input terminals 16ₙ. Similarly the content shown within GUI's 150ₙ in FIGS. 3 to 3b only represents an example of the type of information that can be requested of users 18, of system 10. Accordingly, the present invention should not be construed as being limited to any of the specific examples provided.

The method of capturing and selectively publishing dietary information in accordance with diet capture module 100 of FIG. 2 starts at step 101, wherein a user 18ₙ is prompted to initially enter ‘general’ information to define their personal diet and/or program. FIG. 3 illustrates a suitable GUI 150, which can be used to capture ‘general’ information regarding a user's 18ₙ personal diet and/or program. Referring to FIG. 3, it can be seen that diet capture module 100 of system 10 may capture and selectively publish ‘general’ information including, but not limited to: the title of the diet; a brief description of the diet; a summary of the diet; information and/or history regarding the diet; details of how to follow the diet; cost information regarding the diet; and/or, details of how much weight can be lost whilst following the diet.

At step 102, users 18ₙ are prompted to enter key features and a description of the purpose of their diet. The GUI 150ₙ of FIG. 3 can be used to capture this information. FIG. 3a illustrates a more comprehensive GUI 150ₙ which is accessible to users upon clicking the ‘Edit’ link associated with the ‘Features’ item, or upon expanding the ‘Features’ item, of the GUI 150ₙ shown in FIG. 3.

In FIG. 3a it can be seen that diet capture module 100 of system 10 can capture and selectively publish ‘Features’ of a users 18ₙ personal diet and/or program including, but not limited to: the duration of the diet; the cost of the diet; special dietary requirements of the diet; the recommended exercise required to complement the diet; eating or dining out restrictions relating to the diet; restrictions relating to the consumption of beverages such as, for example, coffee, tea and/or alcohol; resources available about the diet; effort required when cooking whilst following the diet; knowledge of nutritional information required to follow the diet; and/or, nutritional supplements recommended to be taken whilst following the diet.

At decision step 103, users 18ₙ are prompted to advise whether there are any essential tips (see GUI 150ₙ of FIG. 3, which includes a ‘Tips’ item) required to follow the diet and/or program. If there are essential tips, the process continues at step 104 wherein the user 18ₙ is prompted to enter details of the essential tips. Like in the case of the ‘Features’ item of GUI 150ₙ of FIG. 3, the ‘Tips’ item may also link to a suitable, more comprehensive (see for example FIG. 3a), GUI 150ₙ (not shown) for capturing the essential ‘tips’ information. If there are no essential tips, or after the user 18ₙ has entered the essential tips at step 104, the process proceeds to decision step 105.

At decision step 105, users 18ₙ are prompted to advise whether there are any key macro-nutritional requirements for their personal diet and/or program. If there are such requirements, the process continues at step 106 wherein the user 18, is prompted to enter details of the ‘key macro-nutritional requirements’. The GUI 150ₙ of FIG. 3 can be used to capture this information. FIG. 3b illustrates a more comprehensive GUI 150ₙ which is accessible to users upon clicking the ‘Edit’ link associated with the ‘Nutritional Info’ item, or upon expanding the ‘Nutritional Info’ item, of the GUI 150ₙ shown in FIG. 3.

In FIG. 3b it can be seen that diet capture module 100 of system 10 can capture and selectively publish ‘Nutritional Information’ of a users 18ₙ personal diet and/or program including, but not limited to: preferences for foods and/or ingredients of a particular nutritional composition; and/or details of, and comments associated with, particular foods and/or ingredients which can or cannot be eaten whilst following their personal diet.

If there are no ‘key macro-nutritional requirements’, or after the user 18ₙ has entered the ‘key macro-nutritional requirements’ at step 106, the process proceeds to decision step 107.

At decision step 107, users 18ₙ are prompted to advise whether there are any food group constraints associated with their personal diet and/or program. If there are, the process continues at step 108 where the user 18ₙ is prompted to enter details of the ‘food group constraints’. This information can be captured by GUI 150ₙ of FIG. 3b, and/or any other suitable GUI 150ₙ (not shown).

If there are no ‘food group constraints’, or after the user 18ₙ has entered the ‘food group constraints’ at step 108, the process proceeds to decision step 109 wherein a user 18ₙ can select whether their diet is to be published, and hence shared, with other users 18ₙ of system 10 (at steps 110 and 111, respectively).

Additional and/or similar dietary information (not shown) can also be captured and subsequently stored in diet database 24. It should be appreciated that the embodiments of the present invention only represent a selection of the preferred information that can be captured and selectively published in accordance with system 10. Those skilled in the art will appreciate other information which could alternatively or collectively be captured and utilised in accordance with system 10 and as such the present invention is not limited to the specific examples provided.

### Performance Data Module:

System 10 of the present invention also incorporates an application which allows users 18ₙ to evaluate diets and/or programs using a structured framework to determine the suitability of a particular diet and/or program to their specific needs and/or goals.

Performance data module 200 is an example of such a structured application that steps users 18ₙ through a process whereby they can record their performance outcomes, such as, for example, their weight loss whilst following a particular diet. User 18ₙ performance data captured by performance data module 200 can be stored in member database 28, or any other database of system 10. Performance data stored by system 10 can then be made available to other users 18ₙ for the purposes of evaluation of that information.

By capturing user 18, performance information, system 10 is able to offer users 18ₙ the ability to compare their performance in following a particular diet and/or program with other users 18ₙ who may be following the same diet and/or program. By utilising information captured and stored in, for example, member database 28 and/or diet database 24, system 10 can offer users 18, the ability to compare their performance data with other users 18ₙ based on criteria such as age, sex, and/or geographic location.

When assessing a particular diet and/or program, system 10 preferably also enables users 18ₙ to determine whether performance data provided by other users 18ₙ should be considered relevant for the purposes of their assessment. For example, if another user 18ₙ, or group of other users 18ₙ, has not been disciplined when following the particular diet and/or program, the user 18ₙ performing the assessment of the performance data captured for that particular diet and/or program may not wish to include in that assessment the performance data provided by those other users 18ₙ. Accordingly, by utilising information input by users 18ₙ and stored in, for example, member database 28, system 10 is able to provide users 18ₙ with the option of giving weight to other users 18ₙ performance data when conducting an assessment (i.e. evaluating) of a particular diet and/or program.

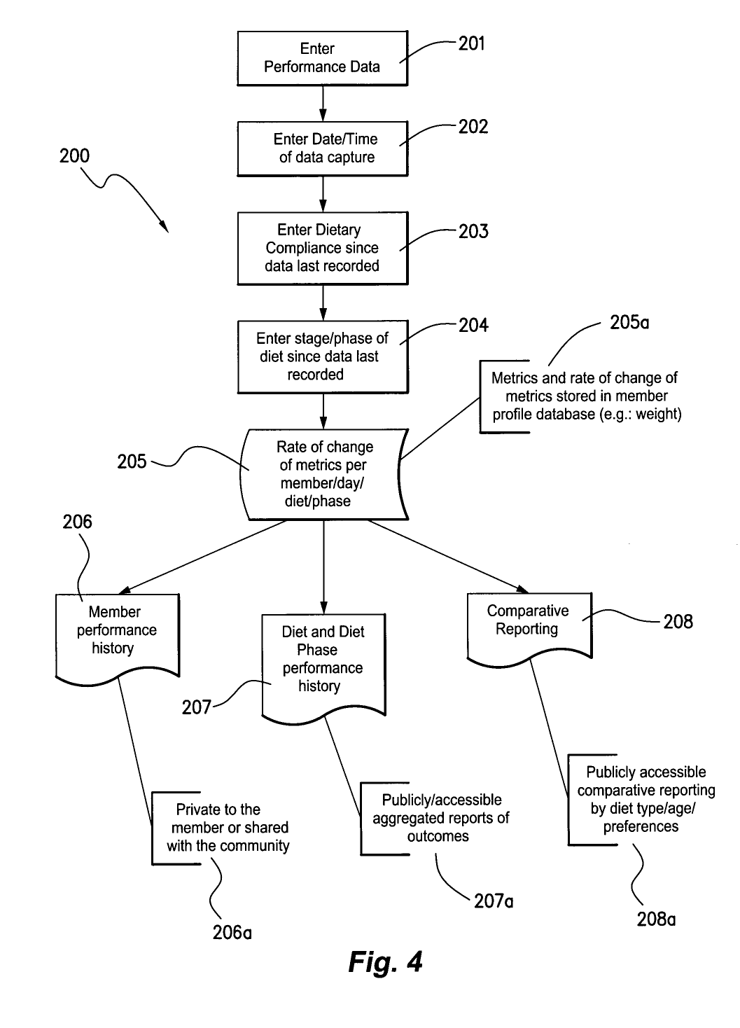

A flow diagram illustrating a preferred performance data module (or method) 200 is shown in FIG. 4. The module 200 of FIG. 4 is suitable for use with system 10 of FIG. 1. It should be understood that the embodiment provided in FIG. 4 only illustrates one way in which performance information can be captured, published and used for evaluation purposes in accordance with system 10. Many other methods may be utilised to achieve the same or similar result and as such the present invention is not limited to the specific example provided.

Although not shown, performance data module 200 of FIG. 4 of system 10, also utilises a GUI(s) for capturing performance information of users 18ₙ. A suitable GUI(s) is a web browser that can display a web-page hosted by computer server 14ₙ (web-server) of system 10. It should be appreciated that any suitable GUI(s) can be used depending on the application of system 10, and the way in which computer server 14ₙ is accessible (via network(s) 12ₙ) to users 18ₙ stationed at input terminals 16ₙ. Accordingly, the present invention should not be construed as being limited to any specific GUI.

The method of capturing performance information in accordance with performance data module 200 of FIG. 4 starts at step 201, wherein a user 18ₙ is prompted to enter initial details of their ‘performance’ data for a particular diet and/or program which may include a range of different metrics, as for example, their current weight and/or measurements.

At step 202, users 18ₙ are prompted to enter the date and time of the data capture. Alternatively, system 10 may simply capture the date and time upon uploading/downloading and storing user 18ₙ performance data in, for example, member database 28. A person skilled in the relevant art would appreciate many ways in which to capture the date and time of data entry and as such the present invention is not limited to the specific examples provided.

At step 203, users 18ₙ are prompted to enter information regarding their ‘compliance’ with the particular diet and/or program since their last performance data was recorded.

At step 204, users 18ₙ are prompted to enter where they are at relative to the stage and/or phase of the diet since their last performance data was recorded.

At step 205, and as indicated in more detail at item 205a, system 10 utilises performance data input by users 18ₙ (at steps 201 to 204) to determine the rate of change of metrics of a user 18ₙ, for example, based on the rate of change of a user 18ₙ per day, diet and/or their current versus previous phase relative to a particular diet.

At steps 206, 207 and/or 208, performance data module 200, of system 10, aggregates the performance data inputted and submitted by users 18ₙ for a particular diet(s) and/or program(s) and disseminates the resulting information into a multitude of different configurations such as, for example, weight loss achieved on a particular diet and/or program for certain users 18ₙ according to a particular profile such as age, sex and/or location, over, for example, a specified period of time. Performance data module 200 of system 10 subsequently stores user 18ₙ performance data and/or outcomes in a database of system 10, as for example, member database 28.

System 10 may utilise data captured at steps 201 to 204 to enable users 18ₙ to evaluate their performance against other users 18ₙ based on other criteria such as, for example, the diet purpose, the features of the diet (such as, for example, the duration of the diet, the cost of the diet, the purpose of a diet, tips relating to a diet, instructions on how to follow a diet, and/or the exercise level required to complement the diet), and/or the nutritional composition relative to the diet. This information having been entered by users (and/or pre-inputted by the system administrators or owners) utilising diet capture module 100 of system 10. Similarly, based on performance information entered by users 18ₙ, system 10 can preferably provide a user 18ₙ with the option of excluding performance data of certain users 18ₙ for the purposes of their own evaluation of a particular diet and/or program.

System 10 enables aggregated performance data captured by performance data module 200 to be privately provided to users 18ₙ at step 206, to be publicly shared with other users 18ₙ of system 10 at step 207 and 208. Diet and diet phase performance history data (step 207) and comparative reporting and analysis of aggregated performance outcomes (step 208) are made available to users 18ₙ through any suitable tailored search facility. Items 206a, 207a & 208a provide a more detailed description of steps 206, 207 & 208, respectively.

### Recipe Capture Module:

In accordance with a further aspect, system 10 enables users 18ₙ to submit and nominate food ingredients, recipes and/or suggestions so that other users 18ₙ who are recorded as following a particular diet and/or program, are able to view and assess the suitability of the food ingredient, recipe and/or suggestion of that other user 18ₙ whom is following the particular diet and/or program.

System 10 incorporates a recipe capture module 300 which is a structured recipe builder which allows users 18ₙ to access food database 22 to select ingredients when building a recipe for other users 18ₙ to share.

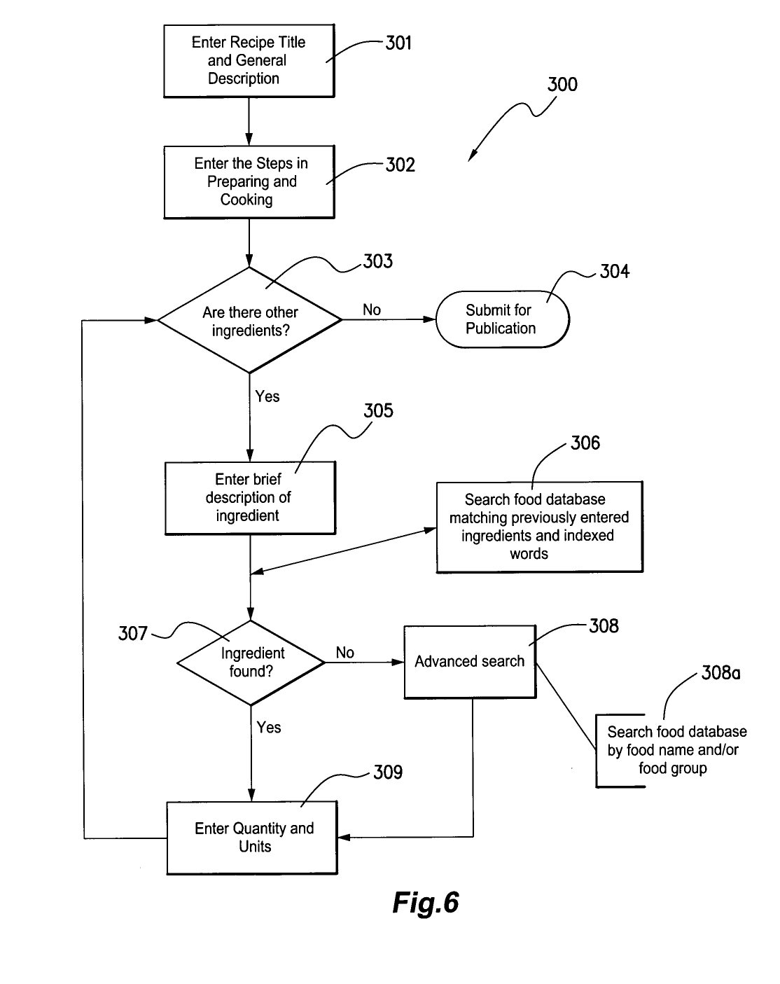

A flow diagram illustrating a preferred recipe capture module (or method) 300 is shown in FIG. 6. The recipe capture module 300 of FIG. 6 is suitable for use with system 10 of FIG. 1. It should be understood that the embodiment provided in FIG. 6 only illustrates one way in which ingredient and/or recipe information can be captured and stored in recipe database 20 in accordance with system 10. Many other methods may be utilised to achieve the same or similar result and as such the present invention is not limited to the specific example provided.

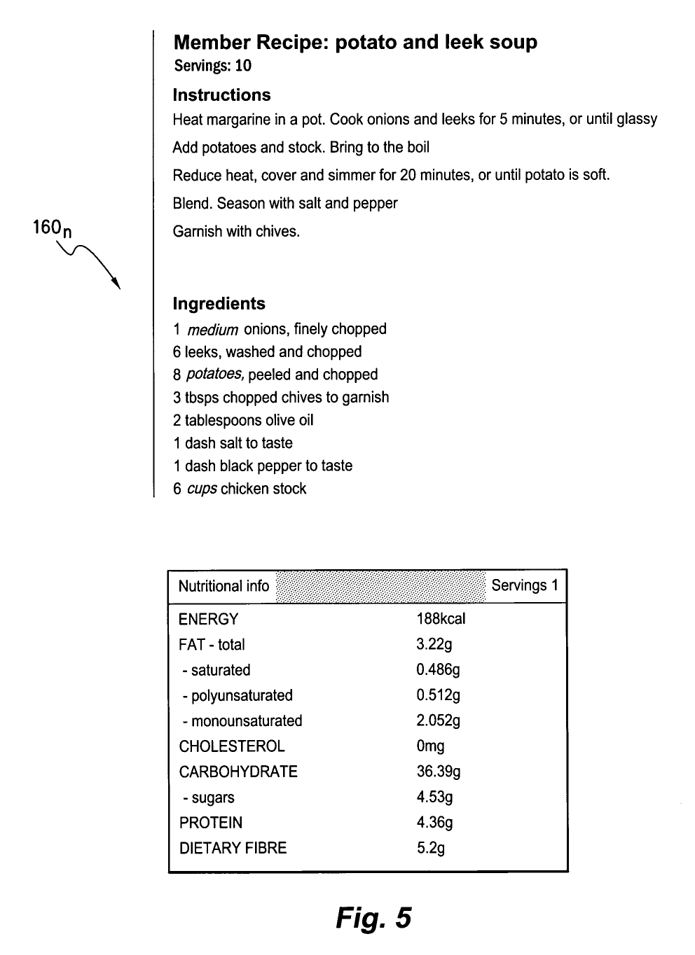

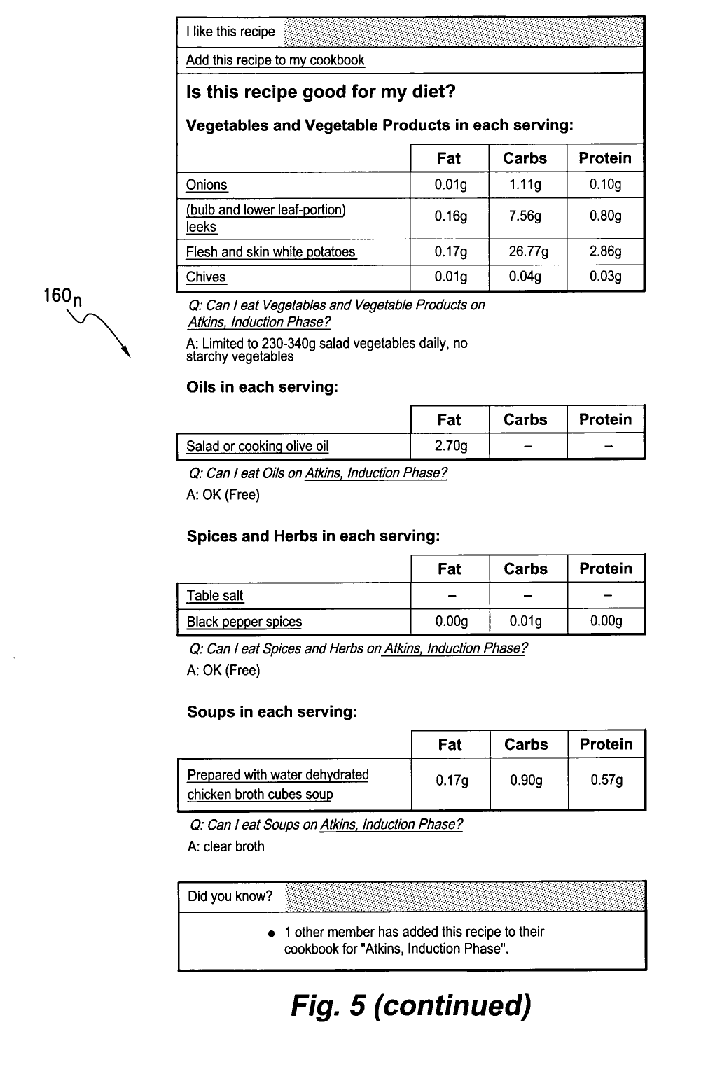

Recipe capture module 300 of FIG. 6 will be described in conjunction with FIG. 5, which illustrates an exemplary GUI 160ₙ for capturing recipe information in accordance with recipe capture module 300 of FIG. 6. In FIG. 5, within GUI 160ₙ is shown a web-page hosted by computer server 14ₙ (web-server) of system 10. It should be appreciated that any suitable GUI(s) 160ₙ can be used depending on the application of system 10, and the way in which computer server 14ₙ is accessible (via network(s) 12ₙ) to users 18ₙ stationed at input terminals 16ₙ. Similarly the content shown within GUI(s) 160ₙ of FIG. 5 only represents an example of the type of information that can be requested of users 18ₙ of system 10. Accordingly, the present invention should not be construed as being limited to any of the specific examples shown.

The method of capturing recipe information in accordance with recipe capture module 300 of FIG. 6 starts at step 301, wherein a user 18ₙ is prompted to initially enter ‘general’ information about their recipe. FIG. 5 illustrates a suitable GUI(s) 160ₙ which can be used to capture ‘general’ information regarding a users 18ₙ recipe. Referring to FIG. 6, it can be seen that recipe capture module 300 of system 10 may capture and publish ‘general’ information including, but not limited to: the title of the recipe; and/or, a general description of the recipe.

At step 302, users 18ₙ are prompted to enter the preparation and/or cooking ‘instructions’ required to prepare the recipe. GUI 160ₙ of FIG. 5 illustrates the layout of a screen after the cooking ‘instructions’ have been captured by recipe capture module 300 of system 10.

At decision step 303, users 18ₙ are prompted to enter the ingredients required for the particular recipe. Steps 303 to 309 are repeated until no more ingredients are required for the recipe, at which time the recipe is complete and recipe capture module 300 of system 10 stores the recipe in recipe database 20, as indicated by step 304. After the recipe is stored in recipe database 20, at step 304, system 10 publishes, and hence shares, the recipe with other users 18ₙ. Although not shown, the publication of a user's 18ₙ recipe may depend on whether that user 18ₙ wishes to share their recipe with other users 18ₙ of system 10. Accordingly, recipe capture module 300 may include an additional step (not shown) of prompting a user 18ₙ for permission to publish their recipe information.

For each ingredient of the recipe, at step 303, users 18ₙ must initially enter a ‘brief description’ of the ingredient at step 305. At intermediate step 306, recipe capture module 300, of system 10, utilises the ‘brief description’ of the ingredient provided by user 18ₙ (at step 305) and searches food database 22 to locate the specific ingredient.

If at decision step 307 the ingredient is not found, the process proceeds to step 308 wherein users 18ₙ are prompted to enter more information about the specific ingredient so that system 10 can perform an advanced search (as indicated by item 308a) of food database 22 to again attempt to located the ingredient. Once the ingredient is located, the process continues at step 309 where the user 18ₙ is prompted to enter the quantity and/or units of the specific (located) ingredient required for the particular recipe. Recipe capture module 300 then returns to step 303, wherein steps 303 to 309 are performed once again until all ingredients have been located and captured, and their specific quantities entered at step 309. The process then concludes at step 304, at which time the recipe is complete and recipe capture module 300 of system 10 stores the recipe in recipe database 20. After the recipe is stored in recipe database 20, system 10 publishes, and hence shares, the recipe with other users 18_{n.}

If at step 307 the ingredient is found, the process proceeds straight to step 309 wherein the user 18ₙ is prompted to enter the quantity and/or units of the specific (located) ingredient required for the particular recipe. Like before, recipe capture module 300 then returns to step 303, wherein steps 303 to 309 are performed once again until all ingredients have been located and captured, and their specific quantities entered at step 309. The process then concludes at step 304, at which time the recipe is complete and recipe capture module 300 of system 10 stores the recipe in recipe database 20. After the recipe is stored in recipe database 20, system 10 publishes, and hence shares, the recipe with other users 18_{n.}

In FIG. 5 GUI 160ₙ illustrates the layout of a screen after all the ‘ingredients’ have been located and captured by recipe capture module 300 of system 10.

What is also displayed within GUI(s) 160ₙ of FIG. 5 is the specific ‘nutritional information’ for the recipe captured by recipe capture module 300. Using the key nutritional elements for distinct food categories previously captured and stored in food database 22, system 10 is able to assess and display the nutritional information for the captured recipe to inform users 160ₙ as to the suitability of the separate ingredients and/or the recipe as a whole.

As system 10 incorporates a classification system (see FIG. 3b) for key food nutritional compositions (such as, for example, fat, carbohydrate, and/or protein) relative to a particular diet and/or program, system 10 is also able to assess and display recipes (and the associated nutritional information for the recipes) captured and stored in recipe database 20 based on dietary preferences for the key nutritional elements that have been submitted by users 18ₙ. Through the application of thresholds for each food sub-group stored in food database 22, system 10 is able to determine the suitability and/or appropriateness of individual food ingredients and/or entire food recipes for a users 18ₙ diet and/or program based on the users 18ₙ nutritional composition classification preferences as illustrated by the GUI 160ₙ shown in FIG. 5.

In FIG. 5, GUI 160ₙ illustrates under the heading “Is this recipe good for my diet?” various information relevant to a recipe and the diet and/or program the user 18ₙ has selected, or is considering to select and follow. It should be appreciated that additional and/or similar information (not shown) may also be displayed to users 18ₙ, via the same or similar GUI 160ₙ. It should therefore be appreciated that the embodiments of the present invention only represent a selection of the preferred information that can be displayed in accordance with system 10. Those skilled in the art will appreciate other information which could alternatively or collectively be displayed and/or utilised in accordance with system 10 and as such the present invention is not limited to the specific examples provided.

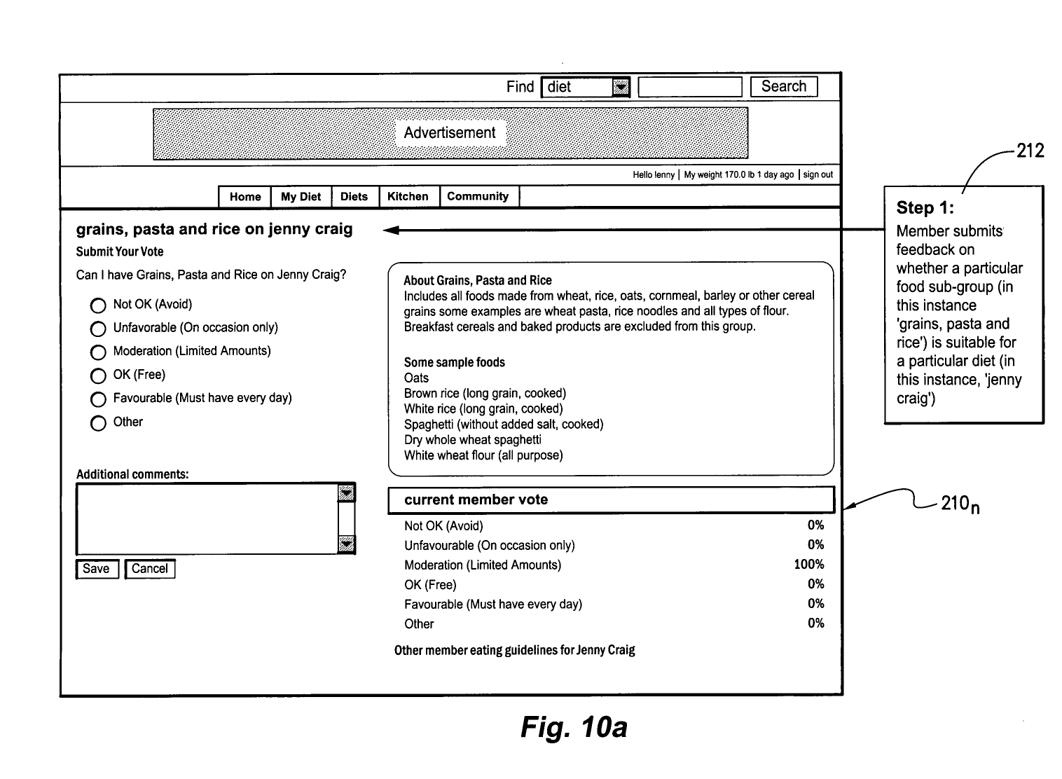

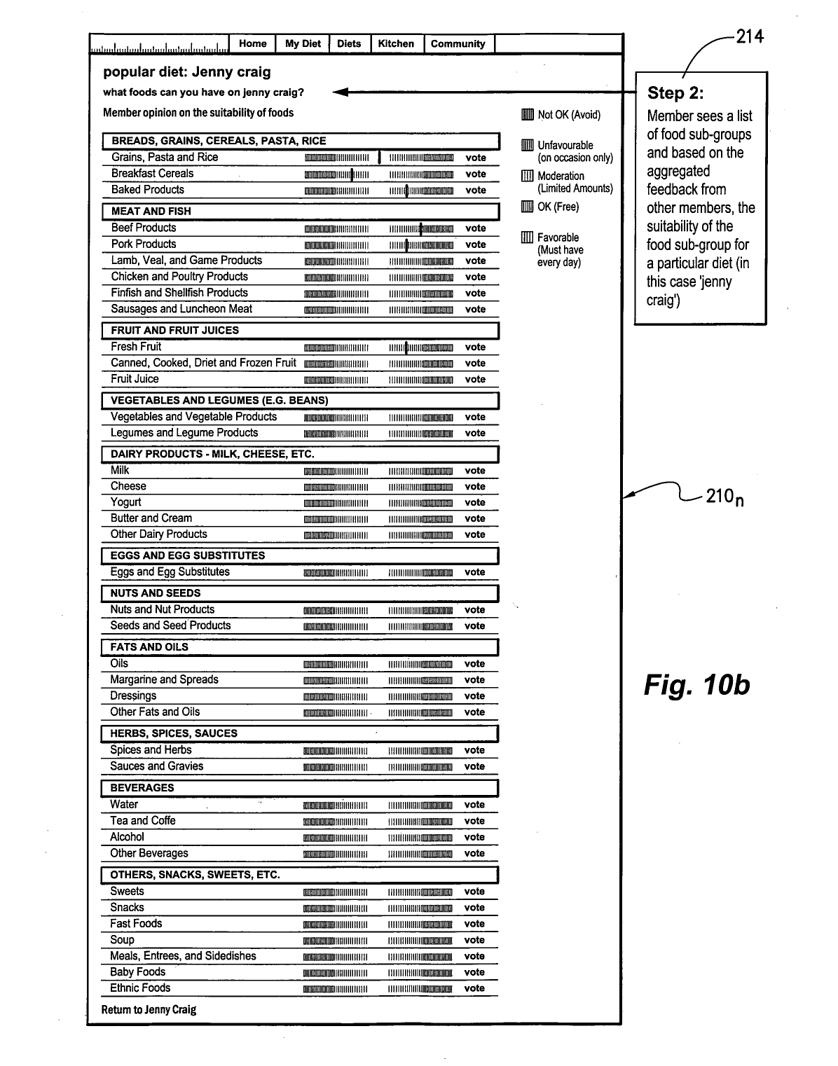

As will be described in more detail later with reference to the example shown in FIGS. 10a and 10b, system 10 may also enable users 18ₙ to provide their own opinions, i.e. to provide feedback for evaluation purposes, as to the suitability and/or appropriateness of individual food ingredients, food sub groups and/or entire food recipes to particular diets and/or programs stored in diet database 24, so that other users 18ₙ can review and evaluate those opinions to assist them in making informed decisions as to the suitability thereof for their own personal needs and/or requirements. In one embodiment, users may utilise a module or application (not shown) of system 10, which may be similar to performance data module 200, to input and publish their own personal assessment information regarding the suitability of individual food ingredients, food sub groups and/or entire food recipes to particular diets and/or programs stored in diet database 24, so that other users 18ₙ are able to view this feedback information in order to evaluate same to determine the suitability for their own specific needs and/or goals.

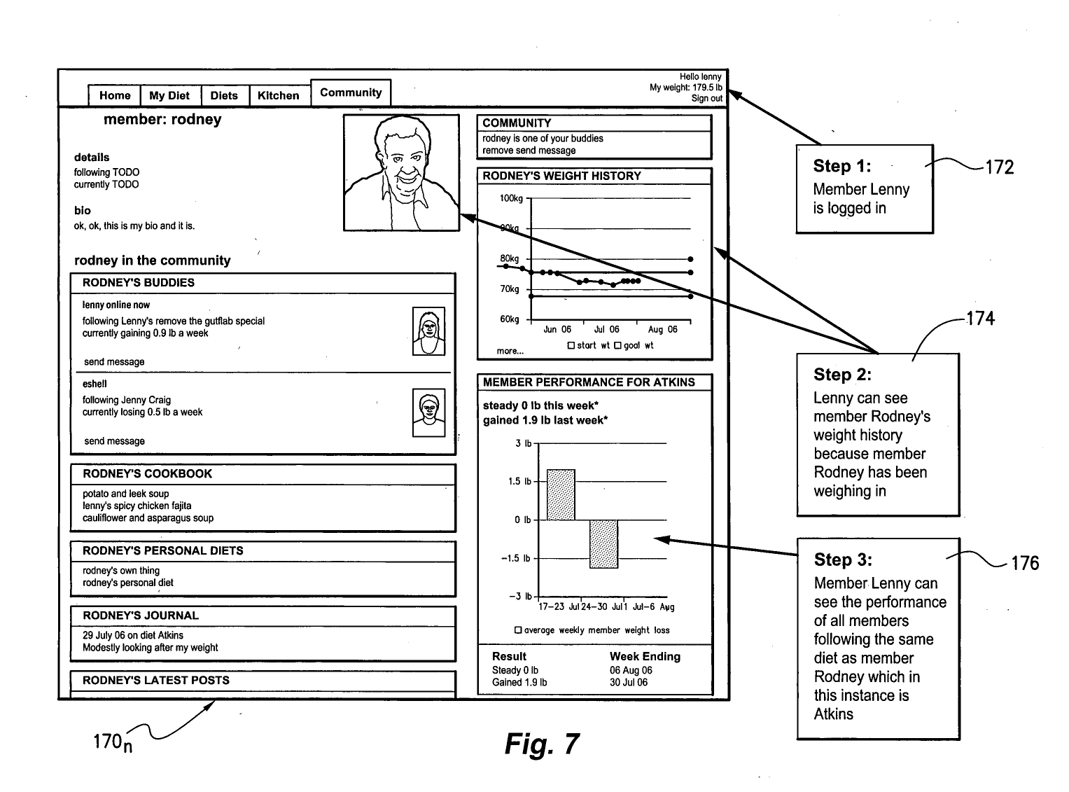

To provide a better understanding of the operation of system 10, a number of examples of possible uses of system 10 will now be described with reference to FIG. 7 to 10b. It should be appreciated that the examples that follow only represent a portion of the possible uses of system 10 and as such the present invention should not be construed as limited to those examples provided.

### User Evaluating Other Users Performance Data

In FIG. 7 there is shown an exemplary GUI 170ₙ, which illustrates an example of one of the many possible uses of system 10 of FIG. 1, wherein it can be seen that a user 18ₙ is able to see the performance data of another user 18ₙ, and/or a group of users 18ₙ, respectively, after those users 18ₙ have entered their performance data for a particular diet and/or program utilising, for example, performance data module 200 of FIG. 4.

In the example shown in FIG. 7, computer server 14ₙ (not shown) of system 10 is at least one web-server which provides an online service to users 18ₙ via the Internet (network 12ₙ), and as such GUI 170ₙ is simply a web browser displaying a web page, or series of web pages, accessible to users 18ₙ via their input terminal(s) 16ₙ (not shown). It is preferred that system 10 of FIG. 7 provides a virtual interactive environment, wherein users 18ₙ of system 10 constitute the individual members of a diet and/or nutrition conscious community.

Referring to FIG. 7 it can be seen in order for a user 18ₙ, to be able to view and evaluate performance data of other users 18, following a particular diet and/or program, they must first log-on to computer server 14ₙ, via network(s) 12ₙ, utilising graphical user interface 170ₙ. At item 172, it can be seen that a user 18ₙ ‘Lenny’ has logged-on to computer server 14ₙ of system 10 and is ready to view and evaluate available performance data.

In the example of FIG. 7 Lenny 18ₙ has selected a particular diet and/or program of interest (in this case, the ‘Atkins’ diet as indicated by item 176) and is able to view the user performance data available for this diet. It should be appreciated that the diet and/or program that is selected may be Lenny's 18ₙ own personal diet (published, for example, via diet capture module 100 of FIG. 2), a system installed diet (as for example, the ‘Atkins’ diet as shown), or any other users 18ₙ personal diet (which may also be published, for example, via diet capture module 100 of FIG. 2). At items 174 & 176 it can be seen that Lenny 18ₙ is able to view (at item 174) the performance data of another user 18ₙ (in this case, ‘Rodney’ 18ₙ), whilst also being able to see (at item 176) the performance data of all other users 18ₙ following the same selected diet and/or program. At items 174 & 176 the available performance data is presented to Lenny 18ₙ, via GUI 170ₙ, in the form of a graph which illustrates the weight fluctuation of those users 18ₙ following the selected diet and/or program.

This example therefore demonstrates that system 10 provides users 18ₙ with a means of evaluating a particular diet and/or program for the purpose of making an informed decision as to whether that diet and/or program is suitable for their individual needs and/or goals. At the same time, if a user 18ₙ is following a particular diet and/or program, the means of evaluating a diet and/or program of system 10 enables a user 18ₙ to compare their own performance data against those of other users 18ₙ following the same diet and/or program, thus providing a means of possibly motivating that user 18ₙ to achieve their personal diet and/or nutritional goals.

### User Publishing Personal Diet, Other Users Following and/or Evaluating that Personal Diet

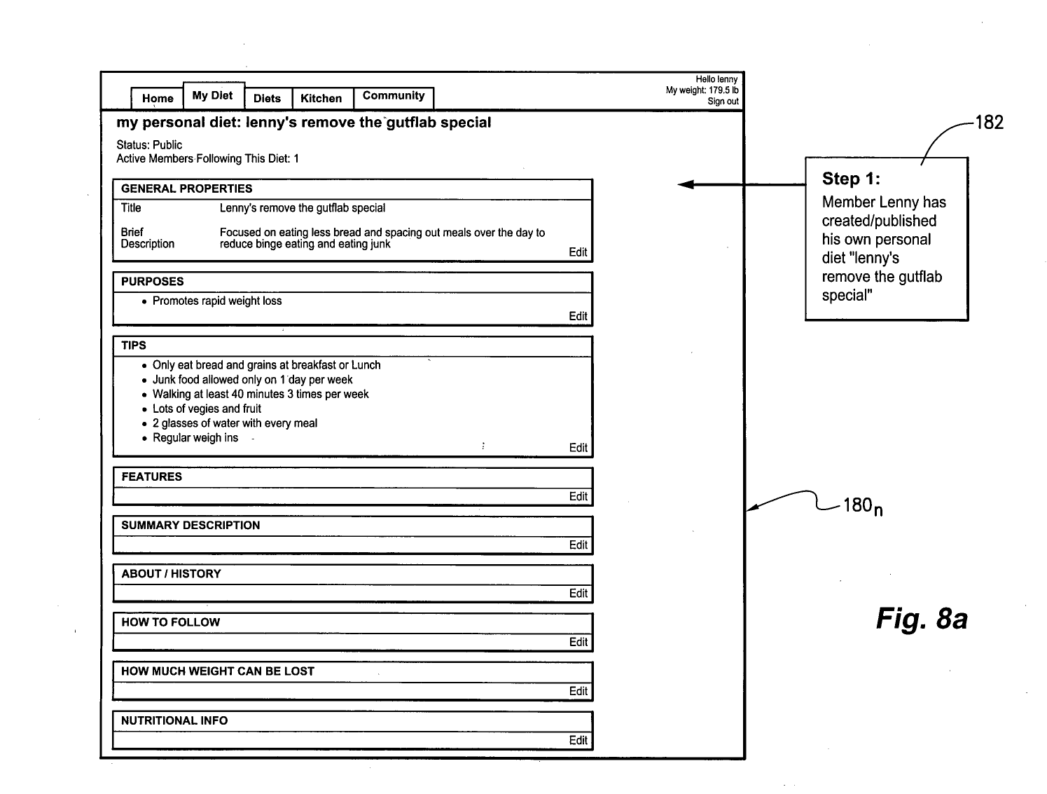

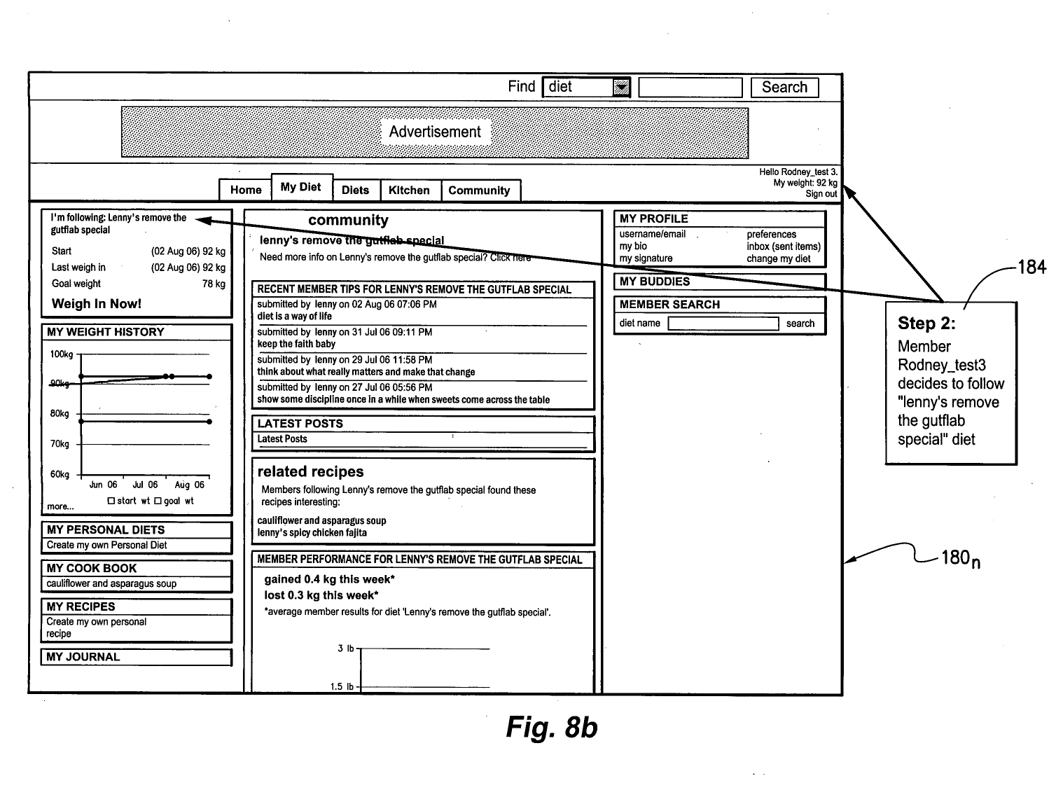

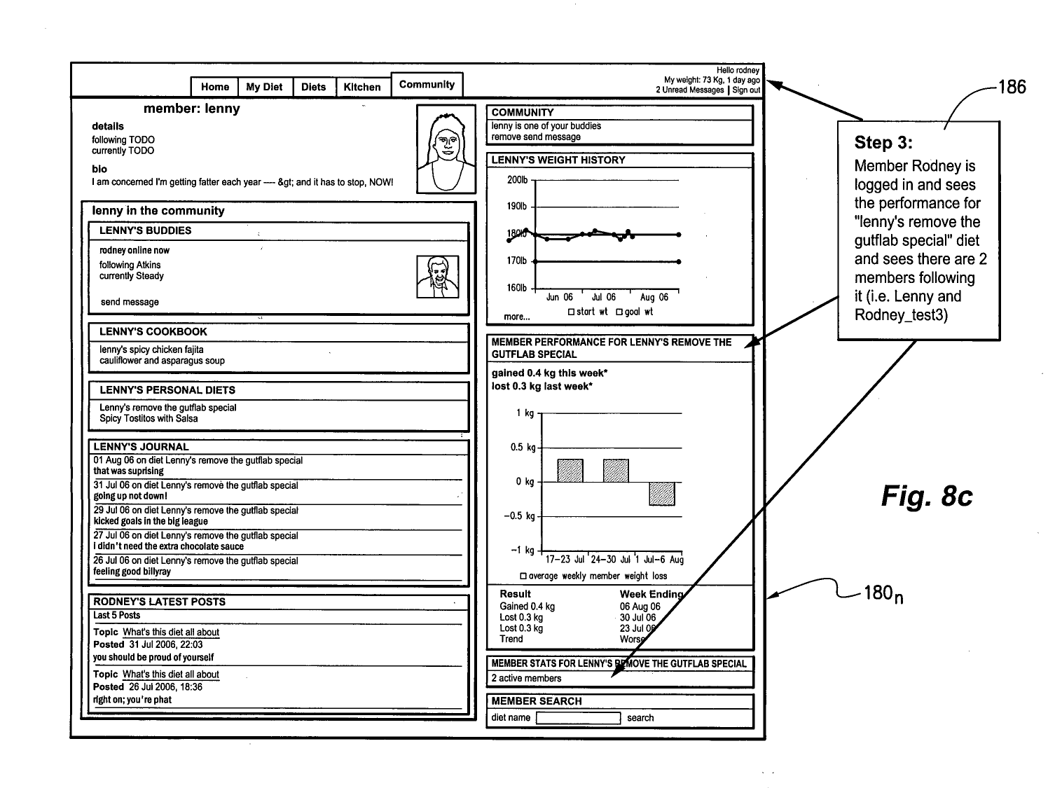

In FIGS. 8a to 8c there are shown exemplary GUI's 180ₙ, which illustrate a further example of the use of system 10, wherein it can be seen that a first user 18ₙ can publish their own personal diet and/or program utilising, for example, diet capture module 100 of FIG. 2, and a second user 18, can then follow that published personal diet, whilst a third user 18, can view the performance data of both the first and second users 18ₙ whom are following that published personal diet after those users 18ₙ have entered their performance data for that published personal diet utilising, for example, performance data module 200 of FIG. 4.

In the example shown in FIGS. 8a to 8c, computer server 14ₙ (not shown) of system 10 is again at least one web-server which provides an online service to users 18ₙ via the Internet (network 12ₙ), and as such GUI's 180ₙ are simply web browsers displaying web pages accessible to users 18ₙ via their input terminal(s) 16ₙ (not shown). Again, it is preferred that system 10 of FIGS. 8a to 8c provides a virtual interactive environment, wherein users 18ₙ of system 10 constitute the individual members of a diet and/or nutrition conscious community.

In FIGS. 8a to 8c, three users 18ₙ are described for the purpose of illustrating this further preferred use of system 10 of the present invention. All three users have logged-on to computer server 14ₙ, via network(s) 12ₙ, utilising GUI 180ₙ. A first user 18ₙ (once again, ‘Lenny’ 18ₙ) creates, publishes and follows his own personal diet (see item 182 of FIG. 8a), a second user 18ₙ (‘Rodney_test3’ 18ₙ) selects and follows (see item 184 of FIG. 8b) Lenny's 18ₙ personal diet, and after the performance data for both Lenny 18ₙ and Rodney_test3 18ₙ is captured and published by system 10, that performance data is made available to a third user 18ₙ (‘Rodney’ 18ₙ) for the purpose of evaluation (see item 186 of FIG. 8c) of Lenny's 18ₙ personal diet.

As indicated by item 182 of FIG. 8a, Lenny 18ₙ has utilised GUI 180ₙ, of system 10, to create and publish his own personal diet called “Lenny's remove the gutflab special”. It is preferred that Lenny's 18ₙ personal diet has been captured and selectively published utilising diet capture module 100 of FIG. 2, but may be captured and selectively published utilising any other suitable method or application (not shown). Lenny 18ₙ then decides to follow his own personal diet and in doing so chooses to record, on an on-going basis, his performance data for that particular diet utilising, for example, performance data module 200 of FIG. 4. It should be appreciated that Lenny's 18ₙ performance data could be captured and published utilising any other suitable method or application (not shown).

At item 184 of FIG. 8b, it can be seen that Rodney_test3 18ₙ has selected to follow “Lenny's remove the gutflab special” diet. Like Lenny 18ₙ, Rodney_test3 18ₙ also chooses to record, on an on-going basis, his performance data for that particular diet utilising, for example, performance data module 200 of FIG. 4. Again, it should be appreciated that Rodney_test3's 18ₙ performance data could be captured and published utilising any other suitable method or application (not shown).

Finally, at item 186 of FIG. 8c, Rodney 18ₙ can then log-on and selectively view and evaluate the available performance data (in this example, Lenny's and Rodney_test3's performance data previously captured utilising, for example, performance data module 200) for “Lenny's remove the gutflab special” diet. In this case, system 10 also enables Rodney 18ₙ to see that there are currently two users 18ₙ (i.e. Lenny and Rodney_test3) following “Lenny's remove the gutflab special” diet. Like in the case of the previous example discussed hereinbefore, the available performance data is presented to Rodney 18ₙ, via GUI 180ₙ, in the form of a graph which illustrates the weight fluctuation of those users 18ₙ (Lenny and Rodney_test3) following “Lenny's remove the gutflab special” diet.

This example therefore demonstrates that system 10 provides users 18ₙ with a means of creating, publishing and following their own personal diet and/or program, whilst at the same time enabling those or other users 18ₙ to evaluate that particular personal diet and/or program for the purpose of making an informed decision as to whether that personal diet and/or program is suitable for their individual needs and/or goals. Like before, if a user 18ₙ is following that particular personal diet and/or program, the means of evaluating a diet and/or program of system 10 enables a user 18ₙ to compare their own performance data against those of other users 18ₙ following the same personal diet and/or program, thus providing a means of possibly motivating that user 18ₙ to achieve their personal diet and/or nutritional goals.

### System Analysing Recipe Information to Determine Suitability for Users Following a Particular Diet

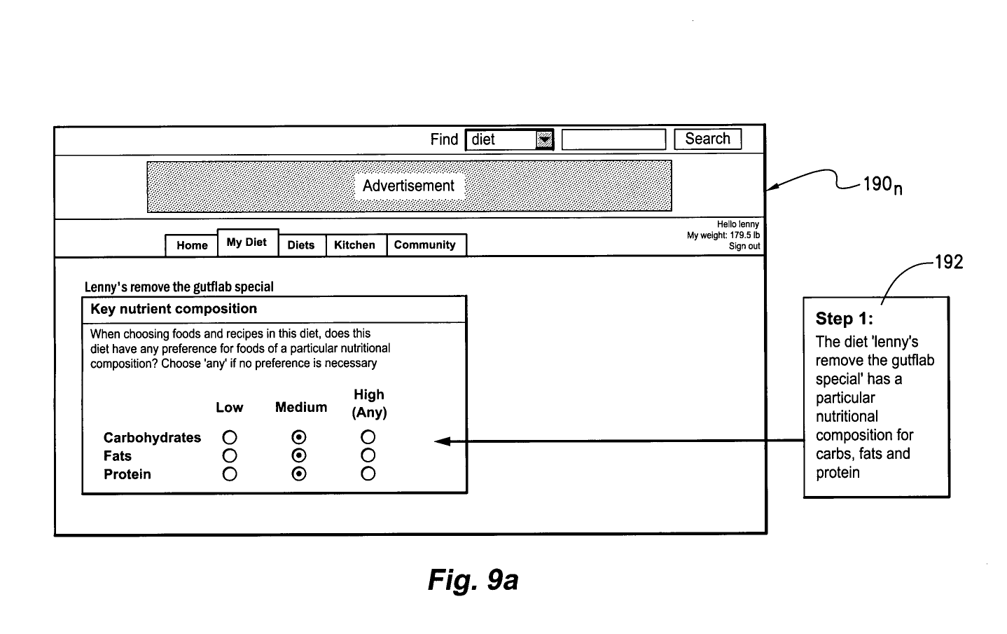

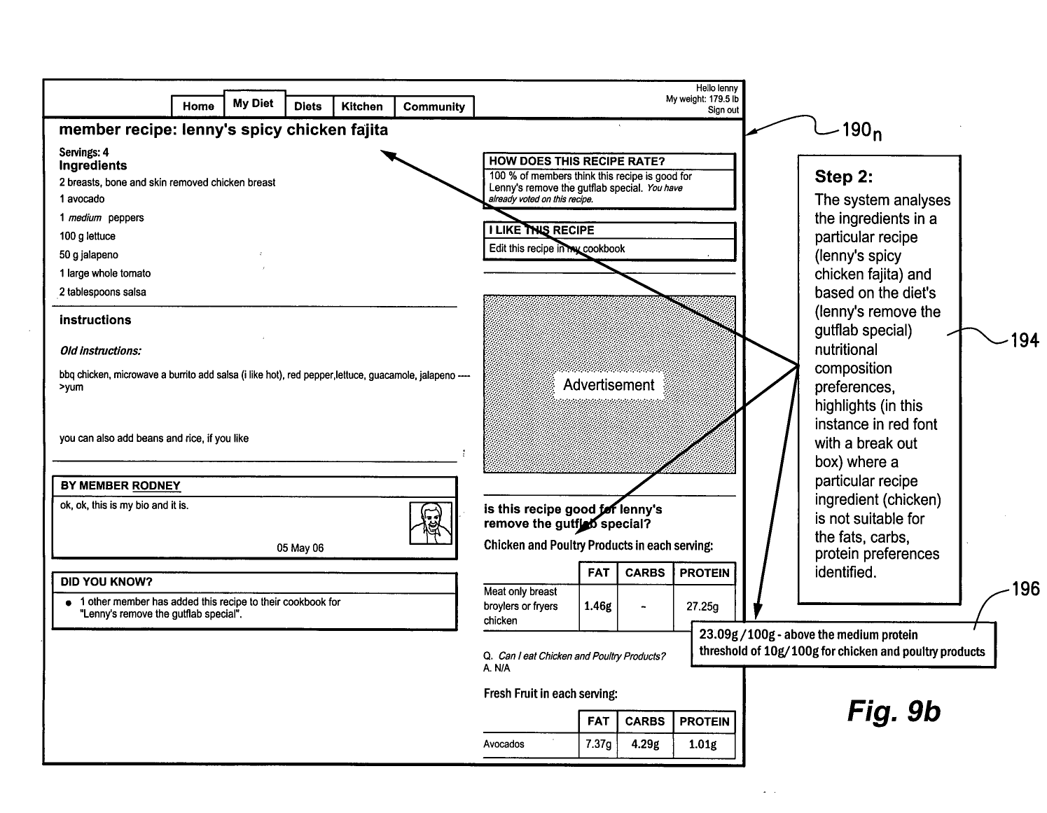

In FIGS. 9a & 9b there are shown exemplary GUI's 190ₙ, which illustrate yet a further example of the use of system 10, wherein it can be seen that if a particular diet published utilising, for example, diet capture module 100 of FIG. 2, has a particular nutritional composition preference or threshold, system 10 will analyse the ingredients of a recipe selected by a user 18ₙ following that particular diet and/or program, which may have been, for example, captured and published utilising recipe capture module 300 of FIG. 6, to determine the suitability of the ingredients of that recipe based on those particular nutritional composition preferences or thresholds.

In the example shown in FIGS. 9a & 9b, computer server 14ₙ (not shown) of system 10 is once again at least one web-server which provides an online service to users 18ₙ via the Internet (network 12ₙ), and as such GUI's 190ₙ are simply web browsers displaying web pages accessible to users 18ₙ via their input terminal(s) 16ₙ (not shown). Once again, it is preferred that system 10 of FIGS. 9a & 9b provides a virtual interactive environment, wherein users 18ₙ of system 10 constitute the individual members of a diet and/or nutrition conscious community.

In FIGS. 9a & 9b, a user 18ₙ (yet again, ‘Lenny’ 18ₙ) has previously published a personal diet utilising, for example, diet capture module 100 of FIG. 2. In this example “Lenny's remove the gutflab special” will be referred to again for simplicity. It should be appreciated, however, that any personal or system installed diet could be used for the purpose of this example. Accordingly, the present invention should not be construed as limited to the specific example provided.

As indicated by item 192 of FIG. 9a, “Lenny's remove the gutflab special” diet has a particular nutritional composition for carbohydrates, fats and/or protein. Having captured these particular compositions when the diet was recorded, system 10 is able to analyse the ingredients of a recipe selected by a user 18ₙ following that particular diet (i.e. “Lenny's remove the gutflab special” diet) to determine, and subsequently inform, that user 18ₙ of the suitability of the ingredients of that selected recipe relative to the particular diet being followed.

At item 194 of FIG. 9b, it can be seen that Lenny 18ₙ has logged-on to computer server 14ₙ, via network(s) 12ₙ, utilising GUI 190ₙ, and has selected a recipe of interest. In this example, the selected recipe is Lenny's 18ₙ own personal recipe (“Lenny's spicy chicken fajita”) previously captured and published utilising, for example, recipe capture module 300 of FIG. 6. It should be appreciated that any personal or system installed recipe may be utilised in accordance with this example of use of the present invention, and as such the present invention is not limited to the specific example provided. Having previously captured the individual compositions of each of the ingredients of the selected recipe (“Lenny's spicy chicken fajita”), and having regard to the preference and/or threshold for those particular compositions relative to the selected diet (“Lenny's remove the gutflab special” diet), system 10 is able analyse (i.e. cross-check) the ingredients of the recipe and subsequently inform the user 18ₙ (in this case, Lenny 18ₙ) of the suitability of the recipe, and/or the individual ingredients, to the selected diet. In the example shown in FIG. 9b, if a particular ingredient (for example, “chicken” as shown) of the recipe (“Lenny's spicy chicken fajita”) is not suitable for the particular diet being followed (“Lenny's remove the gutflab special”), system 10 can make the user 18ₙ (Lenny 18ₙ) aware of same by way of a pop-up box, or the like, for example, box 196 which in practice may have a different colour font, i.e. red font, as described.

This example therefore demonstrates that system 10 provides users 18ₙ with a means of determining the suitability of ingredients of a recipe, and/or the suitability of a recipe as a whole, relative to a particular diet and/or program that is being followed. Thus, system 10 enables users 18ₙ to make informed decisions regarding the selection of not only a diet and/or program to follow, but also ingredients and/or recipes of which they can utilise to assist them in reaching their diet and/or nutrition goals.

### User Providing Feedback as to Whether a Food Sub Group is Appropriate for a Diet and/or Program, Other Users Reviewing that Feedback Information

In FIGS. 10a & 10b there are shown exemplary GUI's 210ₙ, which illustrate yet a further example of the use of system 10, wherein it can be seen that a first user 18ₙ can provide feedback as to whether particular food sub groups are appropriate for particular diets and/or programs, which may be published utilising, for example, diet capture module 100 of FIG. 2, and a second user 18ₙ (and/or other users 18ₙ) can then review the first users 18ₙ (and/or other users 18ₙ) feedback information to assist them in making an informed decision as to whether those particular food sub groups are suitable and/or appropriate for their own personal needs and/or requirements.

In the example shown in FIGS. 10a & 10b, computer server 14ₙ (not shown) of system 10 is once again at least one web-server which provides an online service to users 18ₙ via the Internet (network 12ₙ), and as such GUI's 210ₙ are simply web browsers displaying web pages accessible to users 18ₙ via their input terminal(s) 16ₙ (not shown). Once again, it is preferred that system 10 of FIGS. 10a & 10b provides a virtual interactive environment, wherein users 18ₙ of system 10 constitute the individual members of a diet and/or nutrition conscious community.

In FIG. 10a, it can be seen that a user 18ₙ has logged-on to computer server 14ₙ, via network(s) 12ₙ, utilising GUI 210ₙ, and has selected a particular diet and/or program of interest (in this case, the ‘Jenny Craig’ diet as indicated by item 212). It should be appreciated that the diet and/or program that is selected may be that users 18ₙ own personal diet (published, for example, via diet capture module 100 of FIG. 2), a system installed diet (as for example, the ‘Jenny Craig’ diet as shown), or any other users 18ₙ personal diet (which may also be published, for example, via diet capture module 100 of FIG. 2). Accordingly, the present invention should not be construed as limited to the specific example provided.

After logging-on to computer server 14ₙ, user 18ₙ has chosen to navigate to a section of GUI 210ₙ, wherein they are able to provide feedback regarding the suitability of particular food sub groups (for example ‘grains, pasta and rice’, as shown) relative to their selected diet (‘Jenny Craig’). As indicated by item 212 of FIG. 10a, within GUI 210ₙ, user 18ₙ is presented with a means (see ‘submit your vote’) of voting (i.e. providing feedback information) as to whether they believe the particular food sub group (‘grains, pasta and rice’) is suitable for the selected diet and/or program (‘Jenny Craig’). In this embodiment, under the heading ‘Can I have Grains, Pasta and Rice on Jenny Craig?’ user 18ₙ is presented with six options, namely: ‘Not OK (Avoid)’; ‘Unfavorable (on occasion only)’; ‘Moderation (Limited Amounts)’; ‘OK (Free)’; ‘Favorable (Must have every day)’; and, ‘Other’. In this example, user 18ₙ would select one of the options and may also elect to provide ‘additional comments’ utilising the comment box provided below the (in this case, six) voting options presented to them. User 18ₙ may also utilise the ‘additional comments’ box to specify why they have selected ‘Other’ from the voting options available.

Although not shown in the drawings, system 10 may utilise any suitable module or application, which may be similar to performance data module 200 of FIG. 4, to capture and publish the feedback information submitted via GUI 210ₙ. Similarly, user 18ₙ may provide feedback (i.e. utilising, for example a voting system as shown, and/or any other suitable means of gathering assessment or feedback data that would be deemed appropriate) regarding any number of particular food ingredients, food sub groups and/or entire recipes in accordance with this embodiment, and as such the present invention is not limited to the specific example provided.

As illustrated by the GUI 210ₙ shown in FIG. 10b, after a user 18ₙ has provided their feedback information (or opinion) regarding the suitability of a particular food sub group, etc, another user 18ₙ (or users 18ₙ) can then log-on to computer server 14ₙ and review that feedback information to assist them in making their own opinion regarding same. As indicated by item 214 of FIG. 10b, other users 18ₙ who are interested in a particular diet and/or program (in this case, ‘Jenny Craig’) can select to review the feedback information provided by other users 18ₙ (if available) regarding the suitability and/or appropriateness of particular food sub group(s), to that diet and/or program.

This example therefore demonstrates that system 10 enable users 18ₙ to submit and publish their own personal feedback (assessment) information, or opinions, regarding the suitability and/or appropriateness of individual food ingredients, food sub groups and/or entire food recipes to particular diets and/or programs stored in diet database 24, so that other users 18ₙ are able to review this feedback information in order to make informed decisions as to whether those food ingredients, food sub groups, and/or recipes are suitable and/or appropriate for their own personal needs and/or requirements. Thus, system 10 enables users 18ₙ to make informed decisions regarding the selection of not only a diet and/or program to follow, but also the suitability of particular ingredients, food sub groups and/or recipes to their selected diet and/or program.

Aside from, or in addition to, the ability of system 10 to inform users 18ₙ of the suitability of ingredients of a recipe, and/or the suitability of a recipe as a whole, relative to a particular diet and/or program (see the example provided above and described with reference to FIGS. 9a & 9b), system 10 may also enable users 18ₙ to publish their own opinions as to the suitability of particular, for example, food sub groups, to a particular diet and/or program. Hence, a user 18ₙ may provide their own opinion as to whether they believe a particular food sub group, such as, for example, grains, pasta and rice, is suitable for a particular diet and/or program stored in diet database 24, so that other users 18ₙ can review this feedback information to help them make informed decisions regarding their own personal needs and/or goals.

The present invention therefore provides a system 10 which provides an online community of diet, nutrition and/or weight management conscious individuals who are dedicated to the interactive exchange of opinions, information and results to generate objective useful information that is capable of assisting other members of the community to achieve their diet, nutrition and/or weight management needs and/or goals. The system 10 enabling users to share and evaluate dietary information to assist them in making informed decisions regarding their diet, nutrition and/or weight management needs and/or goals.

While this invention has been described in connection with specific embodiments thereof, it will be understood that it is capable of further modification(s). The present invention is intended to cover any variations, uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. Various modifications and equivalent arrangements are intended to be included within the spirit and scope of the invention and the appended claims. Therefore, the specific embodiments are to be understood to be illustrative of the many ways in which the principles of the present invention may be practiced.

1. A method for sharing and evaluating information, said method comprising:
providing a central repository for storing and sharing dietary information;
providing a plurality of users with controlled access to said central repository and said dietary information stored therein;
storing public dietary information in said central repository and making said public dietary information available to all of said plurality of users;
receiving personal information from at least one of said plurality of users,
storing said personal information in said central repository, and selectively making said personal information available to all of said plurality of users;
receiving feedback information from at least one of said plurality of users regarding said public dietary and/or personal information stored in said central repository;
manipulating said feedback information, storing said manipulated feedback information in said central repository and making said manipulated feedback information available to all of said plurality of users, wherein said manipulated feedback information enables said plurality of users to evaluate said public dietary and/or personal information stored in said central repository.

2. (canceled)

3. The method as claimed in claim, further comprising: receiving a profile from each of said plurality of users, storing each of said profiles in said central repository, and selectively making all or part of said profiles available to all of said plurality of users.

4. The method as claimed in claim 3, wherein each of said profiles comprises: information regarding a users sex; age; geographic location; height; weight; and/or their threshold or tolerance levels for particular foods and/or ingredients; and wherein by making said profiles available, said plurality of users are further able to evaluate said public dietary and/or personal information by considering said manipulated feedback information in association with said profiles of said plurality of users.

5. The method as claimed in claim 1, wherein said public dietary information comprises information regarding well known diet and/or weight loss programs, and wherein said personal information comprises information regarding personal diet and/or weight loss programs captured from at least one of said plurality of users.

6. The method as claimed in claim 5, wherein said public and/or personal diet and/or program information is made available to said plurality of users for the purpose of enabling those users to selectively follow the same.

7. The method as claimed in claim 1, wherein said feedback information received from said at least one of said plurality of users includes performance data for that user which represents their performance achieved whilst following a particular public and/or personal diet and/or weight loss program stored on said central repository.

8. The method as claimed in claim 7, wherein said feedback information is received from said at least one of said plurality of users on an on-going basis.

9. The method as claimed in claim 1, wherein of receiving personal information from at least one of said plurality of users, storing said personal information in said central repository, and selectively making said personal information available to all of said plurality of users, comprises: prompting said user to enter a general description of their personal diet and/or program; prompting said user to enter features and a description of the purpose of their diet and/or program; prompting said user to enter any tips associated with their diet and/or program; prompting said user to enter any nutritional requirements associated with their diet and/or program; prompting said user to enter any food group constraints associated with their diet and/or program; capturing information entered by said user, and storing said captured information in said central repository; prompting said user for permission to make said stored information available to all of said plurality of users, and if said user provides said permission, making said personal information available to all of said plurality of users having access to said central repository.

10. The method as claimed in claim 7, wherein receiving feedback information from at least one of said users regarding said public dietary and/or personal information stored in said central repository; manipulating said feedback information, storing said manipulated feedback information in said central repository and making said manipulated feedback information available to all of said plurality of users; comprises: prompting said user to enter their performance data for the particular diet and/or program being followed; prompting said user to enter the date and time of entering their performance data, or automatically recording the date and time after said performance data is entered; prompting said user to enter where they are at relative to the stage and/or phase of the diet and/or program since their last performance data was entered; capturing feedback information entered by said user, and storing said captured feedback information in said central repository; determining the rate of change of metrics of that user compared to the last time their performance data was entered; manipulating said stored feedback information into a plurality of different configurations for evaluation purposes utilising the rate of change of metrics previously determined; and, making said manipulated feedback information available to all of said plurality of users so that they can evaluate said public dietary and/or personal information stored in said central repository.

11. The method as claimed in claim 5, wherein said public dietary information stored in said central repository further includes information about specific foods, recipes and/or individual ingredients.

12. The method as claimed in claim 11, wherein said information about specific foods, recipes and/or individual ingredients includes nutritional compositions, fat content; carbohydrate levels; and/or protein ratings.

13. The method as claimed in claim 12, wherein said food, recipe and/or ingredient information is stored in food sub-categories or groups within said central repository, with each food group being based on a threshold or tolerance level for a particular diet or category of an individual.

14. The method as claimed in claim 12, wherein said personal information received from said at least one of said plurality of users, stored in said central repository, and selectively made available to all of said plurality of users, further includes personal recipe information which other users can utilise to assist them to achieve their diet and/or weight loss goals.

15. The method as claimed in claim 14, wherein receiving personal information from at least one of said plurality of users, storing said personal information in said central repository, and selectively making said personal information available to all of said plurality of users, further comprises: (i) prompting said user to enter general information about their recipe; (ii) prompting said user to enter the preparation and/or cooking instructions required to prepare their recipe; (iii) prompting said user to enter a brief description of an ingredient of their recipe; (iv) searching said public dietary information stored on said central repository to locate an ingredient that matches said brief description, and when a matching ingredient is found, prompting said user to enter the quantity and/or units of that located ingredient required for their recipe; (v) repeating (iii) and (iv) until all ingredients of the recipe have been located and their specific quantities and/or units entered; and (vi) capturing recipe information entered by said user, and storing said captured information in said central repository; and, (vii) prompting said user for permission to make said stored recipe information available to all of said plurality of users, and if said user provides said permission, making said personal recipe information available to all of said plurality of users having access to said central repository.

16. The method as claimed in claim 15, wherein said method for sharing and evaluating information utilises said public food, recipe and/or ingredient information stored on said central repository as a look-up table during the capture, storage and subsequent, selective, publication of a users personal recipe.

17. The method as claimed in claim 16, wherein information regarding nutritional compositions of the specific ingredients forming part of the captured recipe can be shared with said plurality of users for the purposes of evaluation of that recipe, and wherein, said plurality of users can determine the suitability of that recipe for their own individual needs and/or requirements.

18. The method as claimed in claim 17, wherein nutritional thresholds or preferences for a particular public or personal diet and/or program are stored on said central repository, and further comprising: determining whether a personal recipe, and/or a particular ingredient of that recipe, stored on said central repository is suitable for a particular diet and/or program, and, alerting users as to the suitability of that personal recipe, and/or the particular ingredient(s), to the particular diets and/or programs stored on said central repository.

19. The method as claimed in claim 14, wherein said feedback information received from said at least one of said plurality of users further includes personal assessment data as to whether a particular food, food sub group, recipe and/or ingredient stored on said central repository is suitable for a particular diet and/or program that is also stored on said central repository.

20. The method as claimed in claim 19, wherein receiving feedback information, further comprises: prompting said user to enter feedback information regarding their opinion as to the suitability of a particular food, food sub group, recipe and/or ingredient to a particular diet and/or program stored on said central repository; capturing said feedback information entered by said user, and storing said captured feedback information in said central repository; manipulating said stored feedback information for evaluation purposes; and, making said manipulated feedback information available to all of said plurality of users so that they can evaluate the suitability of said public and/or personal stored in said central repository.

21. The method as claimed in claim 20, wherein said users can also evaluate the opinions of other users regarding the suitability of particular foods, food sub groups, recipes and/or ingredients to particular diets and/or stored on said central repository in order to determine the suitability of those foods or recipes for their own individual needs and/or requirements.

22. The method as claimed in claim 1, wherein said central repository comprises a computing device which comprises a processor which is operable to execute software that maintains and controls access to said information for said plurality of users.

23. The method as claimed in claim 22, wherein said information is stored on a memory associated with said computing device.

24. The method as claimed in claim 22, wherein said computing device comprises a web-server accessible to said plurality of users via a communications network.

25. The method as claimed in claim 24, wherein said communications network is the Internet.

26. The method as claimed in claim 24, wherein each of said plurality of users can access said web-server via a user operable terminal which may be permanently, or selectively, connected to said communications network.

27. The method as claimed in claim 26, wherein said user operable terminal comprises: a PDA; a mobile or cellular telephone; a personal, tablet or notebook computer; or any other suitable communications device.

28. The method as claimed in claim 1, wherein said method for sharing and evaluating information provides an online or virtual community which is accessible to users in real time.

29. A computer-implemented method for sharing and evaluating information, wherein at least a portion of said information is manipulated for evaluation of that information, and said manipulation of said information is performed within memory of a computing device, said method comprising:
providing a central repository on said computing device for storing and sharing dietary information;
providing a plurality of users with controlled access to said computing device, said central repository and said dietary information stored therein;
storing public dietary information in said central repository and making said public dietary information available to all of said plurality of users;
receiving personal information from at least one of said plurality of users, storing said personal information in said central repository, and selectively making said personal information available to all of said plurality of users;
acquiring in said memory of said computing device feedback information from at least one of said plurality of users regarding said public dietary and/or personal information stored in said central repository;
manipulating said feedback information within said memory of said computing device, storing said manipulated feedback information in said central repository and making said manipulated feedback information available to all of said plurality of users, wherein said manipulated feedback information enables said plurality of users to evaluate said public dietary and/or personal information stored in said central repository.

30. (canceled)

31. A machine readable medium storing a set of instructions that, when executed by a machine, cause the machine to:
provide a plurality of users with controlled access to a central repository and dietary information stored therein;
store public dietary information in said central repository and making said public dietary information available to all of said plurality of users;
receive personal information from at least one of said plurality of users, store said personal information in said central repository, and selectively make said personal information available to all of said plurality of users;
receive feedback information from at least one of said plurality of users regarding said public dietary and/or personal information stored in said central repository; manipulating said feedback information, storing said manipulated feedback information in said central repository and making said manipulated feedback information available to all of said plurality of users, wherein said manipulated feedback information enables said plurality of users to evaluate said public dietary and/or personal information stored in said central repository.

32. (canceled)

33. (canceled)

34. (canceled)

35. A system for sharing and evaluating information, said system comprising:
a processor to execute software that maintains and controls access to dietary information for a plurality of users;
a memory to store said dietary information, said dietary information including system installed dietary information that is made available to all of said plurality of users, personal information that is received from at least one of said plurality of users and is subsequently selectively made available to all of said plurality of users, and feedback information that is received from at least one of said plurality of users;
at least one input/output device to provide an interface for said plurality of users to operate said software in order to share said personal information, access said system installed dietarv information, and to provide said feedback information regarding the system installed dietary and/or personal information stored on said at least one memory unit, wherein said feedback information received by said system is manipulated by said software for the purposes of displaying that information to all of said plurality of users for the purpose of evaluation; and, at least one display device operable to present said information to said plurality of users.

36. (canceled)

37. The system as claimed in claim 35, wherein said system installed dietary information comprises information regarding diet and/or weight loss programs, and said personal information comprises information regarding personal diet and/or weight loss programs captured from at least one of said plurality of users, and, said system installed dietary and/or personal diet and/or program information is made available to said plurality of users for the purpose of enabling those users to selectively follow the same.

38. The system as claimed in claim 35, wherein said feedback information received from said at least one of said plurality of users is performance data for that user which represents their performance achieved whilst following a particular diet and/or weight loss program.

39. The system as claimed in claim 38, wherein said feedback information is received from said at least one of said plurality of users on an on-going basis.

40. The system as claimed in claim 35, wherein said personal information is received from at least one of said plurality of users, by utilising a software module of said system which when executed by said processor:
prompts said user to enter a general description of their personal diet and/or program;
prompts said user to enter features and a description of the purpose of their diet and/or program;
prompts said user to enter any tips associated with their diet and/or program;
prompts said user to enter any nutritional requirements associated with their diet and/or program;
prompts said user to enter any food group constraints associated with their diet and/or program;
stores the information entered by said user in said memory; and,
prompts said user for permission to make said stored information available to all of said plurality of users, and if said user provides said permission, makes said personal information available to all of said plurality of users having access to said system.

41. The system as claimed in claim 38, wherein said feedback information is received from at least one of said plurality of users, and subsequently manipulated utilising a software module of said system which when executed by said processor:
prompts said user to enter their performance for the particular diet and/or program being followed;
prompts said user to enter the date and time of entering their performance data, or automatically records the date and time after said performance data is entered;
prompts said user to enter where they are at relative to the stage and/or phase of the diet and/or program since their last performance data was entered;
captures the feedback information entered by said user, and stores said captured feedback information in said memory;
determines the rate of change of metrics of that user compared to the last time their performance data was entered;
manipulates said stored feedback information into a plurality of different configurations for evaluation purposes utilising the rate of change of metrics previously determined; and, makes said manipulated feedback information available to all of said plurality of users so that they can evaluate said system installed dietary and/or personal information stored in said memory.

42. The system as claimed in claim 37, wherein said system installed dietary information stored in said memory further includes information about specific foods, recipes and/or ingredients, more particularly their nutritional compositions, their fat content, carbohydrate levels, and/or protein ratings.

43. The system as claimed in claim 42, wherein said food, recipe and/or ingredient information is stored in food sub-categories or groups within said memory, with each food group being based on a threshold or tolerance level for a particular diet or category of an individual.

44. The system as claimed in claim 42, wherein said personal information received from said at least one of said plurality of users, stored in said memory, and selectively made available to all of said plurality of users, further includes personal recipe information which other users can utilise to assist them to achieve their diet and/or weight loss goals.

45. The system as claimed in claim 44, wherein said system also includes a software module, which when executed by said processor,
(i) prompts said user to enter general information about their recipe;
(ii) prompts said user to enter the preparation and/or cooking instructions required to prepare their recipe;
(iii) prompts said user to enter a brief description of an ingredient of their recipe;
(iv) searches said system installed dietary information stored on said memory to locate an ingredient that matches said brief description, and when a matching ingredient is found, prompts said user to enter the quantity and/or units of that located ingredient required for their recipe;
(v) repeats (iii) and (iv) until all ingredients of the recipe have been located and their specific quantities and/or units entered;
(vi) captures recipe information entered by said user, and stores said captured information in said memory; and,
(vii) prompts said user for permission to make said stored recipe information available to all of said plurality of users, and if said user provides said permission, makes said personal recipe information available to all of said plurality of users having access to said system.

46. The system as claimed in claim 44, wherein said feedback information received from said at least one of said plurality of users further includes personal assessment data as to whether a particular food, food sub group, recipe and/or ingredient stored in said memory is suitable for a particular diet and/or program that is also stored in said memory.

47. The system as claimed in claim 35, wherein said system includes a computing device having said processor and said memory associated therewith.

48. The system as claimed in claim 47, wherein said computing device is connected to a communications network.

49. The system as claimed in claim 48, wherein said computing device is a web-server accessible to said plurality of users via said communications network.

50. The system as claimed in claim 49, wherein said input/output device and said display device are associated with a user operable terminal, wherein each of said plurality of users can access said web-server via the user operable terminal which may be permanently, or selectively, connected to said communications network.

51. The system as claimed in claim 50, wherein said user operable terminal comprises: a PDA; a mobile or cellular telephone; a personal, tablet or notebook computer; or any other suitable communications device.

52. The system as claimed in claim 35, wherein said system for sharing and evaluating information provides an online or virtual community which is accessible to users in real time.

53. A system for sharing and evaluating dietary information, said system being operable over a communications network, said system including:
a central computer server connected to said communications network, said central computer server acting as a central repository for storing and sharing said dietary information; and,
a user operable terminal which can be selectively connected to said communications network for inputting, storing, viewing and retrieving said dietary information from said central computer server, wherein said dietary information stored on said central computer server includes feedback information received from a user of a user operable terminal, said feedback information being manipulated and subsequently made available to all users of said at least one user operable terminal for the purposes of evaluation of other dietary information stored on said at least one central computer server.
